(19) United States
(12) Patent Application Publication
(10) Pub. No.: US 2024/0126509 A1
(43) Pub. Date: Apr. 18, 2024

(54) RANDOM NUMBER GENERATION

(71) Applicant: Analog Devices International Unlimited Company, Limerick (IE)

(72) Inventors: Jonathan Ephraim David Hurwitz, Edinburgh (GB); Jose Bernardo Din, Biclatan (PH)

(21) Appl. No.: 17/963,626

(22) Filed: Oct. 11, 2022

(51) Int. Cl. G06F 7/58

(52) U.S. Cl. CPC G06F 7/58

(57) ABSTRACT

This disclosure relates to apparatus and methods for generating a random number. It is desirable for random numbers to have minimal or no bias towards any of their possible values, such that each possible value that the random number could take has the same, or substantially the same, likelihood. In some examples, the disclosed apparatus and method involve sampling two kTC noise signals from a capacitor(s) and uses the two sampled signals to generate a random number having minimal or no bias. In some other examples, the disclosed apparatus and method additionally or alternatively use a scrambling circuit to generate a scrambled random number using a random number and a random or pseudo-random dither signal.

### TECHNICAL FIELD

The present disclosure relates to apparatus and methods for generating a random number.

### BACKGROUND

This disclosure is concerned with the generation of random numbers where each time a new random number is generated, there is an equal, or substantially equal, likelihood of the random number having any one of its possible values. This may be referred to as a ‘dynamic’ random number as it has the possibility of changing each time a new number is generated. It is in contrast to another type of random number that may be referred to as a ‘static’ or ‘persistent’ random number, where the number generated by different copies of the same apparatus is randomly different, but the number generated by a particular copy of the apparatus should ideally stay the same over time (for example, the number generated by a physical unclonable function—PUF—should be a static random number). Throughout this disclosure, the term ‘random number’ is intended to mean ‘dynamic random number’.

Random numbers are used for a variety of different purposes. Ideally, the likelihood of each possible value of the number should be equal, such that each time a new number is generated there is no bias toward the number having one (or many) particular value(s). However, owing to the physical characteristics of the circuits/apparatus/systems that generate the random number, there can be inadvertent, inherent biases towards particular values, so care should be taken to minimise or remove those. Furthermore, for some uses of random numbers (for example, cryptography) malicious third parties might desire to manipulate the circuits/apparatus/systems generating the random numbers so that the numbers they generate are no longer random. Therefore, it may be desirable for the design and/or operation of the circuits/apparatus/systems to be such that it is difficult for third parties to understand or influence the operations of the circuits/apparatus/systems, thereby improving the security and reliability of the generated random numbers.

### SUMMARY

This disclosure relates to apparatus and methods for generating a random number. It is desirable for random numbers to have minimal or no bias towards any of their possible values, such that each possible value that the random number could take has the same, or substantially the same, likelihood. In some examples, the disclosed apparatus and method involve sampling two kTC noise signals from a capacitor(s) and uses the two sampled signals to generate a random number having minimal or no bias. In some other examples, the disclosed apparatus and method additionally or alternatively use a scrambling circuit to generate a scrambled random number using a random number and a random or pseudo-random dither signal.

In a first aspect of the disclosure, there is provided a random number generation apparatus comprising a first random number generator that comprises a first noise generator circuit comprising: a first capacitor for use in generating kTC noise; and a first buffer coupled to the first capacitor to buffer a capacitor voltage comprising kTC noise generated by the first capacitor and output a buffered voltage; and a determination unit configured to: readout a first buffered voltage from an output of the first buffer, wherein the first buffered voltage is a buffered version of a first capacitor voltage comprising first kTC noise generated by the first capacitor at a first time; and readout a second buffered voltage from the output of the first buffer, wherein the second buffered voltage is a buffered version of a second capacitor voltage comprising second kTC noise generated by the first capacitor at a second time, wherein the random number generation apparatus is configured to generate a random number based on the first buffered voltage and the second buffered voltage.

The noise generator circuit may further comprise a first switch coupled to the first capacitor so as to form a first switched capacitor arrangement such that changing a state of the first capacitor from closed to open generates at the first capacitor a capacitor voltage comprising kTC noise.

The first buffer may be configured to apply a gain to the capacitor voltage to generate the buffered voltage.

The determination unit may comprise a sampling circuit configured to sample the first buffered voltage (and optionally also the second buffered voltage). An input capacitance of the sampling circuit may be greater than a capacitance of the first capacitor.

The sampling circuit may comprise an amplifier comprising at least one capacitor, wherein the sampling circuit is configured to sample the first buffered voltage (and optionally the second buffered voltage) using the at least one capacitor. The amplifier may be an auto-zeroed amplifier.

The determination unit may comprise a comparator configured to compare the sampled first buffered voltage against the second buffered voltage, wherein generation of the random number is based on an output of the comparator.

The sampling circuit may comprise an analog-to-digital, ADC, converter configured to convert the first buffered voltage to a first digital value and convert the second buffered voltage to a second digital value, wherein the random number generation apparatus is configured to generate the random number using the first digital value and the second digital value.

The first random number generator may further comprise a second noise generator circuit comprising: a second capacitor for use in generating kTC noise; and a second buffer coupled to the second capacitor to buffer a capacitor voltage comprising kTC noise generated by the second capacitor and output a buffered voltage; wherein the determination unit is further configured to: readout a third buffered voltage from an output of the second buffer, wherein the third buffered voltage is a buffered version of a third capacitor voltage comprising third kTC noise generated by the second capacitor at the first time, and wherein the first buffered voltage and the third buffered voltage together form a first differential signal (which may be true/fully differential or pseudo-differential); and readout a fourth buffered voltage from the output of the second buffer, wherein the fourth buffered voltage is a buffered version of a fourth capacitor voltage comprising fourth kTC noise generated by the second capacitor at the second time, and wherein the second buffered voltage and the fourth buffered voltage together form a second differential signal (which may be true/fully differential or pseudo-differential), wherein the random number generation apparatus is configured to generate the random number based on the first differential signal and the second differential signal.

The determination unit may further comprise an auto-zeroing differential sampling circuit (which may be true/fully differential or pseudo-differential) configured to sample the first differential signal (and optionally the second differential signal). The determination unit may be configured to generate the random number based on determining a difference between the second differential signal (optionally the sampled second differential signal) and the sampled first differential signal.

The random number generation apparatus may further comprise a scrambling circuit configured to receive the random number generated by the first random number generator and a dither signal that is a random value signal or a pseudo-random value signal, and wherein the scrambling circuit is configured to generate a scrambled random number based on the dither signal and the random number generated by the first random number generator.

The scrambling circuit may be configured to generate the scrambled random number by setting the scrambled random number to equal the random number generated by the first random number generator when the dither signal is a first value and setting the scrambled random number to a value that is different to the random number generated by the first random number generator when the dither signal is a second value. For example, when the dither signal is the second value, the scrambled random number is set to an inverse of the random number generated by the first random number generator. Optionally, the random number generation apparatus may further comprise a second random number generator to generate the random dither signal.

The random number generation apparatus of the first aspect may further comprise: one or more further random number generators of the same design as the first random number generator; and a multi-bit random number unit configured to generate a multi-bit random number based on the random numbers generated using at least some of the one or more further random number generators and the first random number generator. The first random number generator and the one or more further random number generators may be configured to operate in parallel.

In a second aspect there is provided a method for generating a random number, the method comprising a first noise generator circuit comprising: generating a first buffered voltage output from a buffer, wherein the first buffered voltage comprises first kTC noise generated by a capacitor at a first time; generating a second buffered voltage output from the buffer, wherein the second buffered voltage comprises second kTC noise generated by the capacitor at a second time; and generating a random number based on the first buffered voltage and the second buffered voltage.

In a third aspect there is provided an apparatus for generating a scrambled random number, the apparatus comprising: a first random number generator configured to generate a first random number; and a scrambling circuit configured to receive the first random number and a first dither signal, and generate the scrambled random number based on the first random number and the first dither signal, wherein the first dither signal is a random value signal or a pseudo-random value signal.

The scrambling circuit may be configured to generate the scrambled random number by setting the scrambled random number to equal the value of the first random number when the first dither signal is a first value and setting the scrambled random number to a value that is different to the first random number when the first dither signal is a second value. For example, when the first dither signal is the second value, the scrambled random number is set to an inverse of the first random number.

The apparatus may further comprise a first dither generator for generating the first dither signal. Optionally, the first dither generator may comprise a further random number generator configured to generate a further random number, wherein the first dither generator is configured to generate the first dither signal using the further random number. Further optionally, the first dither generator may further comprise a first pseudo-random number generator configured to use the further random number as a seed for generating the first dither signal, wherein the first dither signal is a pseudo-random number output by the first pseudo-random number generator. Additionally or alternatively, the first dither generator may further comprise an entropy correction circuit configured to generate the first dither signal based on the further random number. For example, the entropy correction circuit may be a Von Neumann corrector.

The apparatus may further comprise a plurality of random number generators that includes the first random number generator, wherein the plurality of random number generators are configured to generate a respective plurality of random numbers; and the apparatus may further comprise a first dither generator configured to generate the first dither signal, wherein the scrambling circuit is configured to receive the plurality of random numbers and the first dither signal, and generate a respective plurality of scrambled random numbers using the plurality of random numbers and the first dither signal.

The plurality of random number generators and the first dither generator may be implemented in an integrated chip and are spatially arranged in a row/column. Optionally, the scrambling circuit may be configured to scramble at least two random numbers of the plurality of random numbers using the first dither signal, wherein the at least two random numbers are generated by two random number generators that are spatially non-adjacent in the row. The first dither generator may occupy a position in the row that is spatially non-adjacent to the two random number generators that generate the at least two random numbers.

The apparatus may further comprise: a second dither generator configured to generate a second dither signal, wherein the scrambling circuit is configured to receive the second dither signal, and generate a first set of scrambled random numbers using a first set of random numbers and the first dither signal, and generate a second set of scrambled random numbers using a second set of random numbers and the second dither signal, wherein the plurality of random numbers comprise the first set of random numbers and the second set of random numbers, and wherein the plurality of scrambled random numbers comprise the first set of scrambled random numbers and the second set of scrambled random numbers.

The scrambling circuit may be further configured to: receive one or more further dither signals; and generate the scrambled random number based on the first random number, the first dither signal and the one or more further dither signals. Optionally, the scrambling circuit may be further configured to: generate an intermediate dither signal using the first dither signal and the one or more further dither signals; and generate the scrambled random number using the first random number and the scrambled dither signal.

In a fourth aspect, there is provided a method for generating a scrambled random number, the comprising: generating a first random number; and generating a scrambled random number based on the first random number and the first dither signal, wherein the first dither signal is a random value signal or a pseudo-random value signal.

In a fifth aspect, there is provided a system comprising: a plurality of random number generators configured to generate a corresponding plurality of random numbers; and a multi-bit random number unit configured to: receive at least two of the random numbers generated by the plurality of random number generators; and generate a multi-bit random number using the received at least two random numbers, wherein the plurality of random number generators are configured to operate in parallel such that the plurality of random numbers are generated in parallel.

The plurality of random number generators may comprise a first set made up of the at least two of the random number generators that supply random numbers to the multi-bit random number unit, wherein each of the first set of random number generators comprise a scrambling circuit configured to scramble the random number that is output to the multi-bit random number unit; and wherein the plurality of random number generators further comprises a second set of random number generators that output random numbers to the first set of random number generators for use in scrambling their output random numbers.

Optionally, the plurality of random number generators may be implemented in an integrated chip and are arranged as a series of adjacent columns/rows. A first random number generator whose output random number is used by a second random number generator for scrambling purposes may be spatially separated from the second random number generator.

The multi-bit random number unit may be configured to generate the multi-bit random number by concatenating the received at least two random numbers, wherein an ordering of concatenation changes each time a new multi-bit random number is generated.

### DRAWINGS

Aspects of the present disclosure are described, by way of example only, with reference to the following drawings, in which:

FIG. 1 shows an example schematic representation of a random number generation apparatus/system in accordance with an aspect of the present disclosure;

FIG. 2A shows an example representation of an RC filter circuit that is used to help explain the generation of kTC noise;

FIG. 2B shows an example representation of a basic switched capacitor arrangement for generating kTC noise;

FIGS. 3A to 3G show example implementations of the noise generator circuit of the random number generation apparatus of FIG. 1;

FIG. 4 shows an example process by which the random number generation apparatus of FIG. 1 may determine a random number;

FIG. 5 shows an example implementation of the determination unit of the random number generation apparatus of FIG. 1;

FIG. 6 shows an example implementation of the random number generator of FIG. 1;

FIGS. 7A to 7E show details of further example implementations of the random number generator of FIG. 1;

FIG. 8 shows a further example schematic representation of a random number generation apparatus/system configured to generate a scrambled random number;

FIG. 9A shows a further example schematic representation of a random number generation apparatus/system configured to generate a scrambled random number;

FIG. 9B shows an example implementation of a dither generator;

FIG. 10 shows a further example schematic representation of a random number generation apparatus/system configured to generate a scrambled random number;

FIG. 11 shows a further example schematic representation of a random number generation apparatus/system configured to generate a scrambled random number;

FIG. 12 shows a further example schematic representation of a random number generation apparatus/system configured to generate a scrambled random number;

FIG. 13 shows a further example schematic representation of a random number generation apparatus/system;

FIGS. 14A-14D show details of a further example random number generation apparatus/system configured to generate a plurality of scrambled random numbers;

FIG. 15 shows a further example schematic representation of a random number generation apparatus/system configured to generate a plurality of scrambled random numbers; and

FIG. 16 shows an example process of generating a scrambled random number.

### DETAILED DESCRIPTION

The present disclosure includes a number of different implementations of random number generation apparatus configured to generate a random number where each time a new random number is generated, there is an equal, or substantially equal, likelihood of the random number having any one of its possible values. In some implementations, the random number is generated based on random kTC noise generated by one or more capacitors. kTC noise can be read out from the capacitor(s), but the inventors have recognised that in addition kTC noise, the readout signal will include other components such as low frequency noise, signal offsets/biases in the kTC noise generating circuit and/or the readout circuitry. Those other components mean that a random number generated directly from the readout kTC noise signal is likely to be biased.

However, the inventors have recognised that if they create two consecutive kTC noise events and readout the kTC noise from each, the two readout signals should have the same, or substantially the same, low frequency noise and signal offsets/biases. Therefore, subtracting one signal from the other (i.e., finding the difference) should substantially cancel non-kTC noise from the signals and leave only kTC noise, which is random. Therefore, an improved random number can be generated.

Also disclosed are implementations of a random number generation apparatus that uses scrambling to improve random numbers. In particular, a random number may be scrambled by a scrambling circuit using one or more random or pseudo-random dither signals. In this way, regardless of how the random number is generated, the entropy of the scrambled random number should be the same or greater than that of the random number, such that the scrambled random number is improved (i.e., it has less or no bias towards any of its possible values).

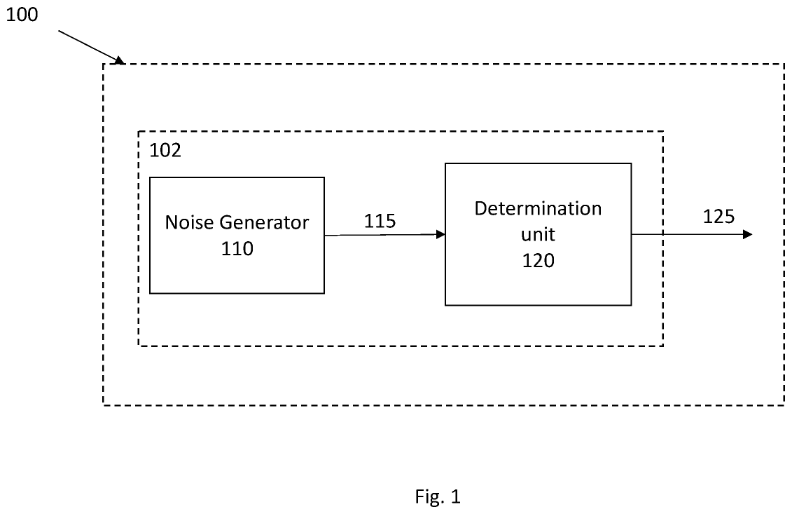

FIG. 1 shows an example schematic representation of a random number generation apparatus/system 100 in accordance with an aspect of the present disclosure. It comprises a random number generator 102 that comprises a noise generator circuit 110 and a determination unit 120. In some example implementations, the random number generation apparatus/system 100 will comprise more than one random number generator 102, but for the sake of simplicity a single random number generator 102 will initially be described. The noise generator circuit 110 is configured to generate a buffered voltage 115 that is output to the determination unit 120. The determination unit 120 is configured to use the output buffered voltage 115 to generate a random number 125.

In some implementations, the first noise generator circuit 110 may comprise a capacitor that is configured to generate random kTC noise, wherein the random buffered voltage 115 comprises kTC noise generated by the capacitor.

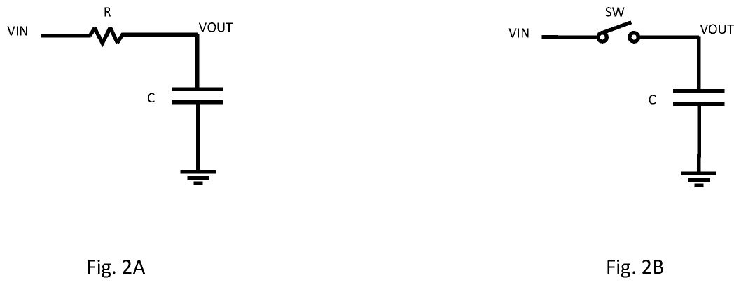

FIG. 2A shows an example representation of an RC filter circuit that is used to help explain the kTC noise that may be generated by a capacitor. The RC filter circuit has a resistor R and a capacitor C and the thermal noise vₙ in the signal VOUT may be expressed as:

$${v}_{n} = \sqrt{4 * {k}_{B} * T * R * BW} \to BW = \frac{1}{4 RC}$$

$${v}_{n} = \sqrt{4 * {k}_{B} * T * R * \frac{1}{4 RC}}$$

$${v}_{n} = \sqrt{\frac{{k}_{B} * T}{C}}$$

where
T=temperature
k_{B}=Boltzmann constant

The thermal noise vₙ is generally referred to as kTC noise, and that is how it will be referred to in the remainder of this disclosure. The kTC noise is random and follows a Gaussian distribution where

$$\sqrt{\frac{{k}_{B} * T}{C}}$$

is the sigma of the Gaussian distribution.

In an example, at a temperature of 27° C. (300K) the kTC noise of the capacitor C would be:

| Capacitance | | $\sqrt{\frac{{k}_{B} * T}{C}}$ |
|---|---|---|
| 1 | fF | 2.03 mV |
| 10 | fF | 644 uV |
| 100 | fF | 204 uV |
| 1 | pF | 64 uV |

FIG. 2B shows an example representation of a basic switched capacitor arrangement for generating kTC noise. The switch SW can be modelled as a varying resistor depending on the state of the switch. The kTC noise generated by this circuit is the same as that of the RC filter circuit represented in FIG. 2A. When the switch is turned from an on (i.e., closed) state to an off (i.e., open) state, kTC noise is injected across the capacitor C. Consequently, changing the state of the switch SW from a closed state to an open state may be seen as generating a capacitor voltage VOUT that comprises kTC noise.

The inventors have recognised that because the generated kTC noise is random, it may be used to generate a random number. For this purpose, it may be preferable for the noise to be as large as possible. The kTC noise may be increased by reducing the capacitance of the capacitor C, as can be seen from the table above. However, smaller capacitors have smaller energy, which then makes it harder to read and use the signal VOUT.

The inventors realised that a buffer could be used to read very small capacitor voltages VOUT by buffering the capacitor voltage VOUT. By doing so, the capacitance of the capacitor C may be set to a very small value such that the kTC noise component of the capacitor voltage VOUT is relatively large. By maximising the contribution of kTC noise in the capacitor voltage VOUT, the randomness of any random number generated using the capacitor voltage VOUT may be improved. However, using a buffer to readout the capacitor voltage VOUT introduces additional challenges. For example, it may be desirable to use a buffer that has a low input capacitance, as the buffer input capacitance may contribute to the capacitance of the switched capacitor circuit. Since it is desirable to have a very small capacitance in order to maximise the kTC noise, any additional capacitance from the buffer input may be undesirable. However, buffers with relatively small input capacitance tend to have relatively large offset errors, which may reduce the randomness of the buffered voltage output from the buffer, and therefore also reduce the randomness of any random number then generated based on the buffered voltage.

Faced with all of these challenges and considerations, the inventors have configured the apparatus 100 such that the noise generator circuit 110 generates a first buffered output voltage 115 comprising first kTC noise and the determination unit 120 reads out the first buffered output voltage 115. Subsequently, the noise generator circuit 110 generates a second buffered output voltage comprising second kTC noise and the determination unit 120 reads out the second buffered output voltage 115. The determination unit 120 may then generate a random number 125 based on a comparison of the first and second buffered output voltages. By performing this two-step process of kTC noise generation, the resultant signal from the comparison may have a reduced level of undesirable, persistent components such as DC bias, low frequency noise and buffer offset (i.e., non-random components, that would thereby reduce the randomness of the random number), such that the random number generated using the result of the comparison should have improved randomness. Furthermore, since buffer offset can be reduced or cancelled by using the two buffered output voltages, a buffer with a small input capacitance may be used, thereby increasing the size of the kTC noise component in the buffered output voltage.

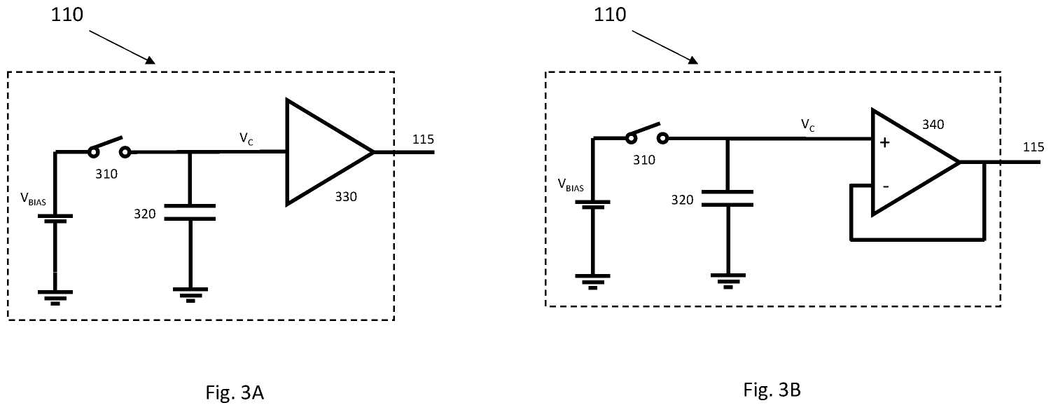

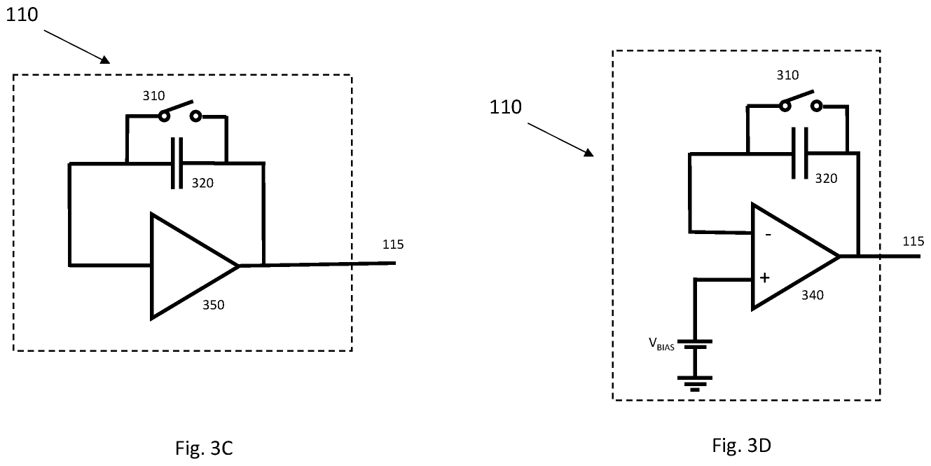

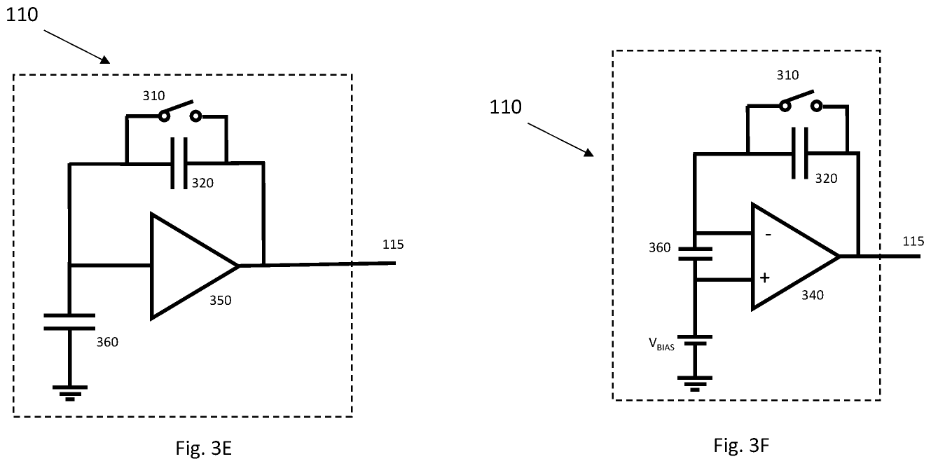

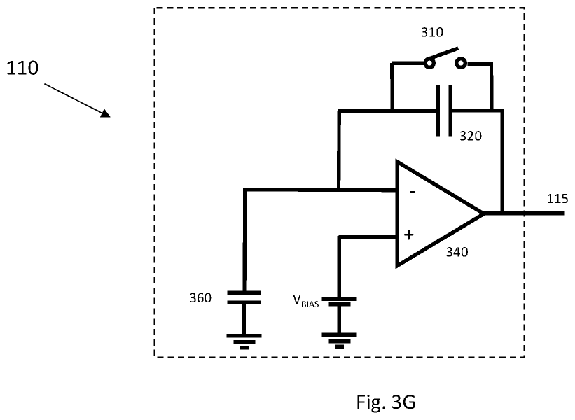

FIG. 3A shows an example implementation of the noise generator circuit 110. The noise generator circuit 110 comprises a switch 310 and a capacitor 320 and is arranged such that when the switch 310 state is changed from closed to open, the bias voltage V_{BIAS} and kTC noise is sampled on the capacitor 320. The bias voltage V_{BIAS} may be set to be any voltage including a positive voltage, negative voltage or 0V. The switch 310 may be any suitable type of controllable switch, for example a transistor such as a MOS type transistor, which may be of either p or n type depending on the level of V_{BIAS}. The noise generator circuit 110 further comprises a buffer 330 that is configured to buffer the capacitor voltage V_{C} to generate the buffered voltage 115. The buffer may be of any suitable type, for example a source-follower.

FIG. 3B shows a further example implementation of the noise generator circuit 110. It is of the same design as that shown in FIG. 3A, except it has a different type of buffer 340. In this example, the buffer 340 is a differential amplifier with negative feedback and may be of any suitable type, for example an op amp. Both buffer 330 and buffer 340 provide functionality to isolate the low capacitance circuit that precedes the buffer from potentially relatively high input capacitances at the determination unit 120 input (described in more detail later). Consequently, it helps to maintain a small capacitance for generating the kTC noise, thereby increasing the size of the generated kTC noise. Furthermore, both buffer 330 and buffer 340 provide functionality to increase the drive strength of the kTC noise signal (i.e., the drive strength of the buffered voltage 115 is greater than the capacitor voltage V_{C}), which makes it easier for the determination unit 120 to use the kTC noise in generating the random number. The primary difference between the two buffers 330 and 340 is that buffer 330 may have a larger offset voltage than buffer 340, but that offset voltage should be largely or entirely cancelled by double sampling the capacitor 320 and by the operation of the determination unit 120, as described later.

FIGS. 3C and 3D show further example implementations of the noise generator circuit 110. In the implementation of FIG. 3C, a single ended amplifier 350 (of any suitable type, for example a straightforward single stage common-source amplifier) is used. In the implementation of FIG. 3D, a differential amplifier 340 is used. In both implementations, the noise generator circuit 110 is configured such that the buffered output voltage 115 is a gained up version of the capacitor voltage (which comprises kTC noise), where the gain is equivalent to the ratio of the input capacitance of the amplifier 340/350 to the capacitance of capacitor 320.

FIGS. 3E, 3F and 3G show further example implementations of the noise generator circuit 110. These implementations are very similar to those of FIGS. 3C and 3D, except that they further include an additional capacitor 360, which has a relatively large capacitance compared with the capacitor 320 that is used for kTC noise generation. In all of these three implementations, the noise generator circuit 110 is configured such that the buffered output voltage 115 is a gained up version of the capacitor voltage (which comprises kTC noise), where the gain is equivalent to the ratio of the capacitance of capacitor 360 to the capacitance of capacitor 320.

The voltages in all of FIGS. 3A, 3B, 3D, 3E, 3F and 3G are shown relative to ground, but the circuits may alternatively be configured to use any other suitable reference voltage.

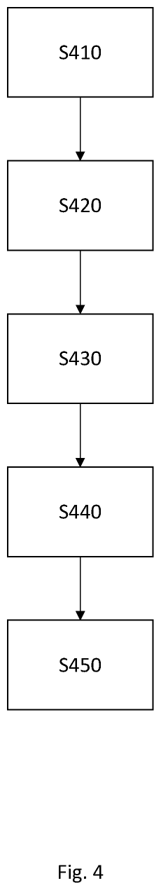

FIG. 4 shows an example diagram of a process by which the random number generation apparatus 100 may determine a random number.

In Step S410 at a first point in time, the noise generator circuit 110 generates a first capacitor voltage across capacitor 320, wherein the first capacitor voltage comprises first kTC noise. A first buffered voltage that is a buffered version of the first capacitor voltage is output from the noise generator circuit 110. The noise generator circuit 110 may be controlled to do this by controlling the state of the switch 310 to change from a closed state to an open state. That control may be exercised, for example, by control unit that may be part of the determination unit 120, or may be external to the determination unit (for example, a central controller that controls the operation of multiple random number generators 102 if the random number generation apparatus is configured to have multiple random number generators 102, as explained later). The control unit may take any suitable form that would be well understood by the skilled person, for example it may be implemented by a dedicated circuit/logic, or an FPGA, or a microcontroller or processor, or any other type of logic that is configured to control the state of the switch 310.

In Step S420, the determination unit 120 reads the first buffered voltage from the noise generator circuit 110. As explained in more detail below, this first buffered voltage may be sampled by the determination unit 120 or otherwise held/stored for use later in generating the random number.

In Step S430 at a second point in time subsequent to the first point in time, the noise generator circuit 110 generates a second capacitor voltage across capacitor 320, wherein the second capacitor voltage comprises second kTC noise. A second buffered voltage that is a buffered version of the second capacitor voltage is output from the noise generator circuit 110. The noise generator circuit 110 may be controlled to do this by first returning the state of the switch 310 to a closed state and then at the second point in time changing the state of the switch 310 from the closed state to an open state. Again, this control may be exercised in any suitable way, as explained above.

In Step S440, the determination unit 120 reads the second buffered voltage from the noise generator circuit 110. As explained in more detail below, this second buffered voltage may be sampled by the determination unit 120 or otherwise held/stored for use later in generating the random number.

In Step S450, the random number generation apparatus may generate the random number 125 based on the first buffered voltage and the second buffered voltage. For example, the first buffered voltage and the second buffered voltage may be compared to generate the random number 125. In one example, the comparison may determine the value of a single bit random number 125, for example setting the single bit randomly to a 0 or 1. In particular, if, for example, the first buffered voltage is larger than the second buffered voltage, the random number may be set to 0 (or alternatively 1), and if the first buffered voltage is smaller than the second buffered voltage, the random number may be set to 1 (or alternatively 0). In some examples, the determination unit 120 itself may perform this step and output the random number 125, as is represented in FIG. 1. However, alternatively, this step may be performed elsewhere in the random number generation apparatus with the determination unit 120 outputting values that are indicative of the first and second buffered voltages to some other unit/module within the random number generation apparatus 100 where the random number 125 is then determined.

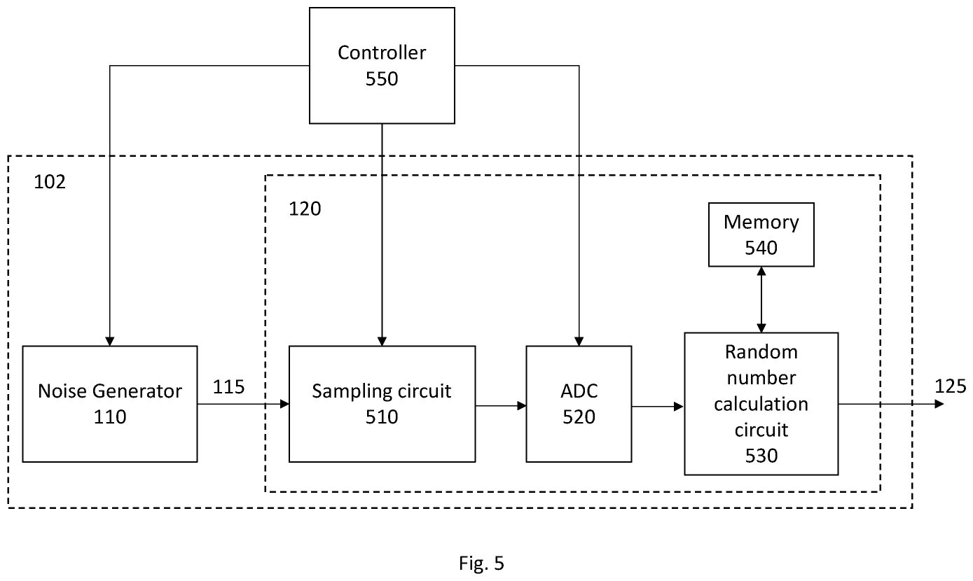

FIG. 5 shows an example implementation of the determination unit 120 when it is configured to generate the random number 125. In this example, a controller 550 is represented for controlling the operation timings of the noise generator 110, sampling circuit 510 and ADC 520, in order to execute the functionality described above with reference to FIG. 4. The controller 550 may optionally be part of the random number generation apparatus 100 (not represented in FIG. 4 for the sake of simplicity). The controller 550 may also be used to control the operation timings of one or more other random number generators 102 in the random number generation apparatus 100, if the apparatus 100 comprises more than one random number generator. In an alternative, the controller 550 may be part of the random number generator 102, such as part of the determination unit 120 (for example, it may form part of the random number calculation circuit 530).

The determination unit 120 comprises a sampling circuit 510 that is configured to sample the first buffered voltage at Step S420. The sampling circuit 510 may be implemented in any usual way that will be well understood by the skilled person. The sampled voltage is then converted to a digital value by the analog-to-digital converter (ADC) 520, which is then received by the random number calculation circuit 530. The ADC 520 may be any suitable type of ADC 520, for example a flash ADC, a SAR AC, a sigma-delta ADC, a ramp ADC, etc. The random number calculation circuit 530 may then store in memory 540 the digital value that is indicative of the first buffered voltage. Again, the memory 540 may be of any suitable type, for example volatile or non-volatile. Whilst the memory 540 is shown as being part of the determination unit 120, it may alternatively be located anywhere in the random number generation apparatus 100, for example being shared by multiple random number generators 102.

Subsequently, the sampling circuit 510 may by reset and then sample the second buffered voltage at Step S440, which can then be digitally converted by the ADC 520. Optionally, the random number calculation circuit 530 may store that digital value in memory 540.

Finally, the random number calculation circuit 530 may determine the random number 125 using the first stored digital value and the second digital value, for example by setting the random number 125 to 0 or 1 depending on which digital value is larger (as explained earlier). In the event that the two digital values equal each other, the random number calculation circuit 530 may be configured to behave in a number of different ways. For example, it may repeat the steps of FIG. 4 until the two numbers are not equal, at which point the random number 125 will be generated. Or, it may be configured to assign pseudo-randomly the random number 125 to 0 or 1 whenever the digital values are equal, for example using a received pseudo random dither signal.

The random number calculation circuit 530 may be configured in any suitable way to perform this functionality. For example, it may be implemented in hardware, such as a dedicated circuit, or FPGA, or it may be implemented by software executed on logic, such as on one or more processors such as a microprocessor(s) or microcontroller(s).

Whilst the random number calculation circuit 530 is represented as being part of the determination unit 120, it may alternatively be located elsewhere on the random number generation apparatus 100, for example being shared by one or more other random number generators 102 in the case where the apparatus 100 comprises more than one random number generator 102. In this case, the determination unit 120 would not generate the random number 125. Instead, the first and second digital values would be output from the determination unit 120 to the random number calculation circuit 530 and the random number 125 would be generated there.

In an alternative, the determination unit 120 may be configured to compare the two sampled voltages in the analog domain. For example, the determination unit 120 may comprise a circuit having first and second sampling capacitors, wherein the determination unit 120 is configured to sample in Step S420 the first buffered voltage to the first sampling capacitor and to sample in Step S440 the second buffered voltage to the second sampling capacitor. A differential ADC may then generate a multi-bit digital representation of the differential between the first buffered voltage and the second buffered voltage, based on which the random number 125 may be generated (for example, the random number may be set to 0 (or 1) if the output of the ADC shows that the first buffered voltage is greater than the second buffered voltage, and may be set to a 1 (or 0)) if the output of the ADC shows that the second buffered voltage is greater than the first buffered voltage. In an alternative, the determination unit may not comprise a multi-bit ADC, but may instead comprise a comparator configured to compare the two sampled voltages and output a single bit digital representation of the comparison, set to 0 or 1 depending on the comparison (for example, the single-bit representation may show whether the first buffered voltage is greater than or less than the second buffered voltage). The comparator's output may be single ended or differential. The output of the comparator would in this example be the random number 125.

In each of the above examples, the random number generator 102 has a single noise generator circuit 110 (or ‘first noise generator’), such that the signal received at, and used by, the determination unit 120 is a single ended signal. However, in an alternative implementation the random number generator 102 may comprise two noise generator circuits, each outputting buffered voltages that together form a differential signal. The determination unit 120 then receives that differential signal and it is used to generate the random number 125. In this case, and as described in more detail below, the determination unit 120 may be configured similarly to FIG. 5. Alternatively, the determination unit 120 may not have an ADC 520 configured to digitally convert the first buffered differential voltage and digitally convert the second buffered differential voltage, wherein the difference between the two is subsequently determined in the digital domain. Instead, the determination unit 120 may be configured to determine the difference between the first buffered differential voltage and the second buffered differential voltage in the analog domain. That difference may then be converted to a digital representation, which may be a multi-bit digital representation of the difference, or a single bit representation of the difference (for example, a single-bit representation showing whether the kTC noise generated by the first noise generator is greater than or less than the kTC noise generated by the second noise generator).

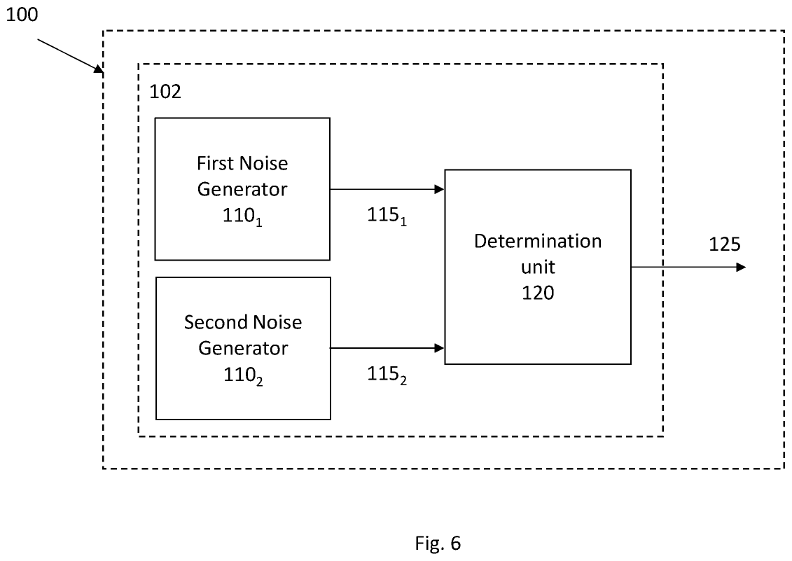

FIG. 6 shows an example implementation of a random number generator 102 having a first noise generator circuit 110₁ and a second noise generator circuit 1102. The first and second noise generator circuits may be of identical design and may be implemented in any of the ways described earlier, for example those shown in FIGS. 3A-3F. Referring to the process described above with reference to FIG. 4, in Step S410, at the first point in time, the first noise generator circuit 110₁ may generate the first capacitor voltage across its capacitor 320₁ (wherein the first capacitor voltage comprises first kTC noise) and the second noise generator circuit 110₂ may generate a third capacitor voltage across its capacitor 320₂ (wherein the third capacitor voltage comprises third kTC noise) by controlling their respective capacitor switches, as described earlier. The first buffered voltage 115₁ is output from the first noise generator circuit 110₁ and a third buffered voltage 115₂ is output from the second noise generator circuit 110₂. These two buffered voltage signals together form a first differential signal. The term “differential” is used in the present disclosure to include both true or fully differential (where the signals making up the differential signal are both produced by a single structure centred on a common voltage) and pseudo differential (where each of the two signals making up the differential signal are produced by differential structures not necessarily centred on a common mode voltage, but where the two structures are designed to have the same DC bias, as is the case in the example of FIG. 6).

In Step S420, the determination unit 120 reads the first differential signal from the first and second noise generator circuits. The first differential signal may be sampled or otherwise held/stored for use later in generating the random number. For example, if the determination unit 120 implemented as described above with reference to FIG. 5, the sampling circuit 510 may sample the differential signal in any suitable way and the ADC 520 may be configured to receive for conversion the sampled value a single ended or differential signal, depending on the configuration of the sampling circuit 510. Alternatively, the determination unit 120 may not have an ADC 520 and may instead use a comparator, examples of which are described later.

In Step S430 at the second point in time subsequent to the first point in time, the first noise generator circuit 110₁ generates the second capacitor voltage across its capacitor 320₁ (wherein the second capacitor voltage comprises second kTC noise) and the second noise generator circuit 110₂ generates a fourth capacitor voltage across its capacitor 320₂ (wherein the fourth capacitor voltage comprises fourth kTC noise) by controlling their respective capacitor switches, as described earlier. The second buffered voltage 115₁ is output from the first noise generator circuit 110₁ and a fourth buffered voltage 115₂ is output from the second noise generator circuit 110₂. These two buffered voltage signals together form a second differential signal.

In Step S440, the determination unit 120 reads the second differential signal from the first and second noise generator circuits. Optionally, the determination unit 120 may sample or otherwise hold/store the second differential signal.

In Step S450, the random number generation apparatus 100 may generate the random number 125 based on the first differential signal and the second differential signal. For example, a difference between the first differential signal and the second differential signal may be found in order to generate the random number 125, in the same way as described earlier and as further described below.

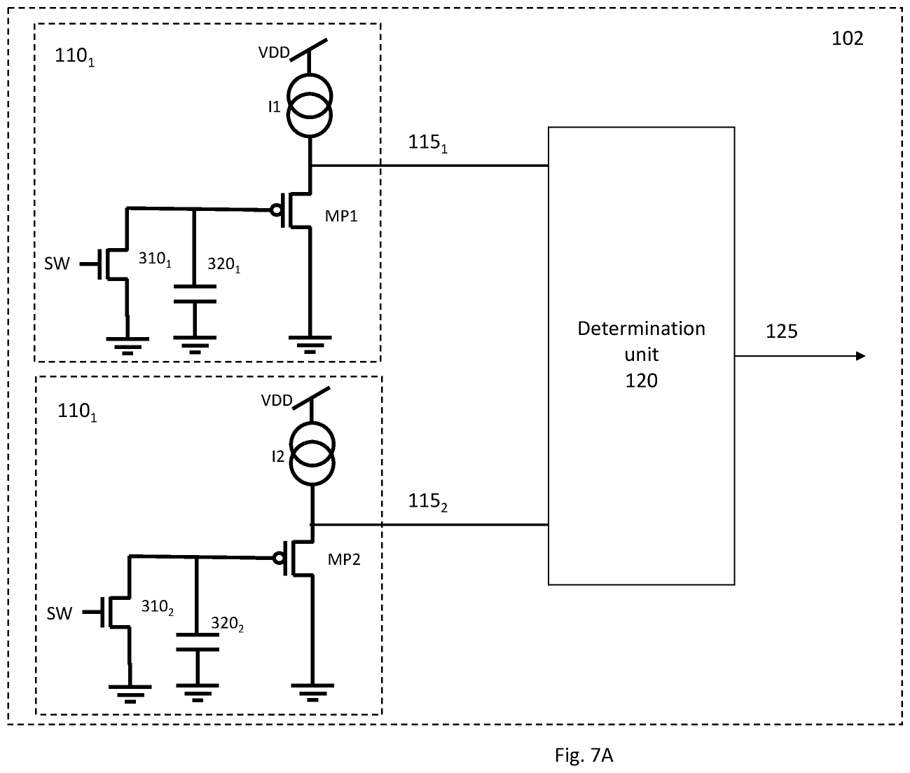

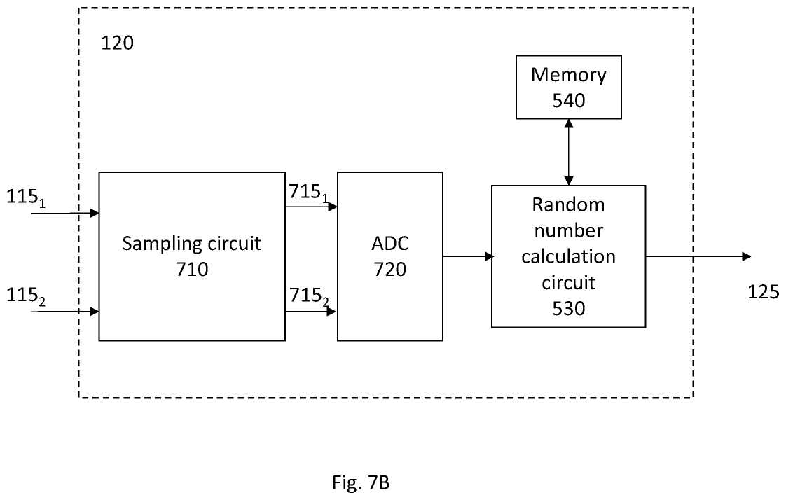

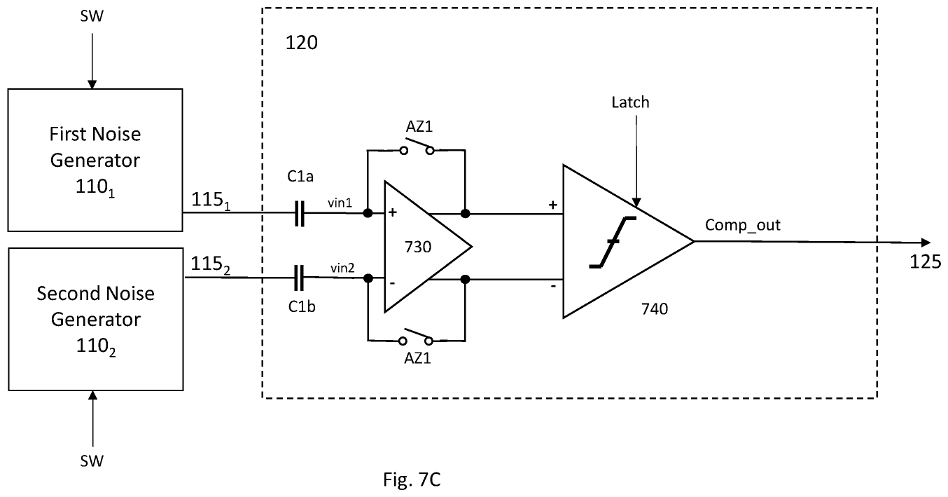

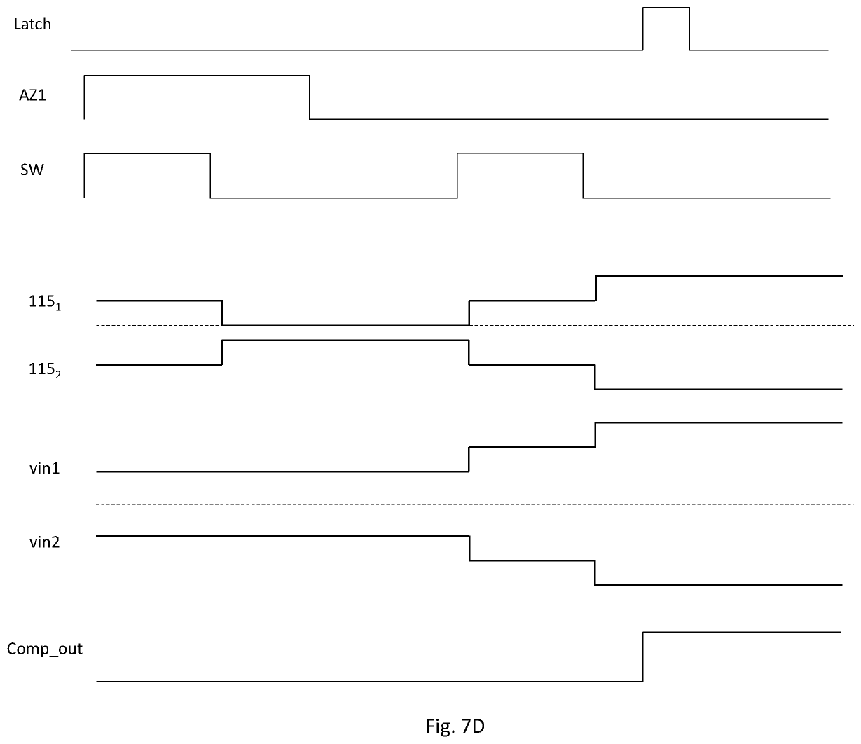

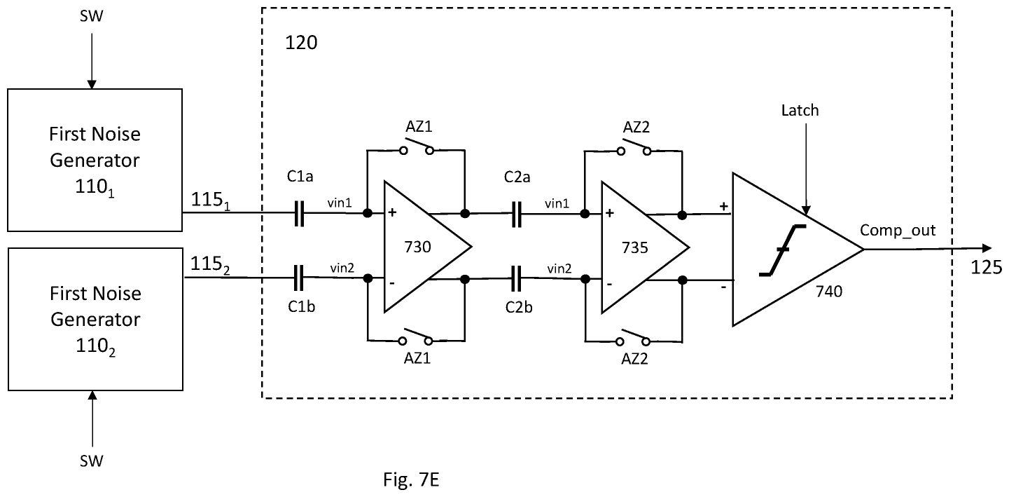

FIG. 7A shows an example implementation of the first and second noise generators 1101 and 1102, although it will be appreciated that for each noise generator any other suitable configuration may be used where a capacitor voltage comprising kTC noise can be generated and a buffered signal output (for example any of the implementations of FIGS. 3A-3F, or any other suitable implementation). The switch 310 of each of the noise generators is implemented using a FET, the state of which is controlled by control signal SW (which may be controlled using a controller that is part of the random number generator 102 or is located anywhere else in the random number generation apparatus 100 or indeed outside of the random number generation apparatus 100). The buffer of each of the noise generators is implemented using the respective current sources I1 and 12 and the respective FETs MP1 and MP2. Differences in the components of each of the noise generators may contribute to undesirable signal components within the buffered voltages 115₁ and 115₂ that might reduce the randomness of the number generated using the buffered voltage 115₁ and 115₂. For example, each of the generated capacitor voltages may have slightly different DC offsets owing to differences in the switches 310₁ and 310₂ and/or differences in the capacitors 320₁ and 320₂, which would carry through to the buffered output voltages 115₁ and 115₂. Additionally, or alternatively, each of the buffers may have a different offset owing to component differences, which would result in an offset between the buffered output voltages 115₁ and 115₂. However, because the differential signal at a first point in time (the first differential signal) is compared to the differential signal at the signal point in time (the second differential signal) in order to generate the random number, and each of those differential signals should have the same or very similar offset components, those undesirable signals may be significantly reduced or entirely cancelled, leaving only the kTC noise which is useful for random number generation.

In all of FIGS. 6, 7A, 7B, 7C and 7E, the two noise generation circuits 110₁ and 110₂ are represented as differential structures not necessarily centred on a common mode voltage, such that the signals 115₁ and 115₂ together form a pseudo differential signal. However, they could alternatively be configured such that the signals 115₁ and 115₂ together form a true/fully differential signal. For example, rather than using a separate buffer for each kTC capacitor 320, a single differential buffer could be used with the capacitor voltage (comprising kTC noise) of each of capacitors 320₁ and 320₂ being received at respective inputs to the differential buffer. The skilled person will readily appreciate various different types of suitable differential buffers that may be used. In this case, the first and second noise generator circuits may be considered together to comprise first and second capacitors 320₁ and 320₂ and a differential buffer configured to output a differential signal based on the capacitor voltages of the first and second capacitors 320₁ and 320₂.

FIG. 7B shows one example implementation of the determination unit 120 represented in FIG. 7A. FIG. 7C shows an alternative example implementation of the determination unit 120 represented in FIG. 7A.

Starting with FIG. 7B, the differential signal 115₁ and 115₂ is received and sampled by sampling circuit 710, and the sampled differential signal 715₁ and 715₂ is received and converted by the ADC 720. Operation of this example implementation is the same as that described above with reference to FIGS. 4 and 5. In particular, in Step S410, the first differential signal is output from the first noise generator circuit 110₁ and the second noise generator circuit 110₂. In Step S420, the determination unit 120 reads the first differential signal from the first and second noise generator circuits by sampling the first differential signal in any suitable way, which will be well understood by the skilled person. Optionally, the sampling circuit 710 may also include a gain or amplifier circuit, such as a pre-amp. The ADC 720 then digitally converts the sampled first differential signal and the digital output of the ADC 720 is handled by the random number calculation circuit 530 in the same way as described above with reference to FIG. 5. The first differential signal converted by ADC 720 comprises a difference between the kTC noise generated by the first noise generator circuit 110₁ and the kTC noise generated by the second noise generator circuit 110₂ in the first switching event of the noise generator capacitors, as well as any DC offsets between the two signals making up the differential signal (for example, caused by one or more of low-frequency noise, offsets in the driving voltages of the noise generator circuits, offsets caused by the buffers of the noise generator circuits, amplifier offset if the sampling circuit 710 includes a pre-amp, etc).

Subsequently, sampling circuit 710 is reset and in Step S430 the second differential signal is output from the first noise generator circuit 110₁ and the second noise generator circuit 110₂. In Step S440, the determination unit 120 reads the second differential signal from the first and second noise generator circuits by sampling the second differential signal. The ADC 720 then digitally converts the sampled second differential signal and the digital output of the ADC 720 is handled by the random number calculation circuit 530 in the same way as described above with reference to FIG. 5. The second differential signal converted by ADC 720 comprises a difference between the kTC noise generated by the first noise generator circuit 110₁ and the kTC noise generated by the second noise generator circuit 110₂ in the second switching event of the noise generator capacitors, as well as the DC offsets between the two signals making up the differential signal.

Finally, in Step S450, the random number generation apparatus 100 generates the random number 125 based on the first and second digital outputs of the ADC 720. For example, the random number calculation circuit 520 may compare the first and second digital values and set the random number 125 to 0 or 1 depending on whether the difference between the first and second digital values is positive or negative, as described earlier with reference to FIG. 5. By comparing the two digital values (for example, subtracting one from the other), the DC offsets in the signals may be cancelled out such that only random kTC noise remains, based on which the random number 125 is generated.

In the alternative represented in FIG. 7C, the sampling circuit is implemented as an auto-zeroed sampling pre-amp, comprising a gain stage 730, autozero switches AZ1 and sampling capacitors C1a and C1b. The gain stage 730 may be any suitable type of differential amplifier gain stage, which will be well understood by the skilled person. If the differential signal formed by 115₁ and 115₂ is a pseudo-differential signal (as is the case in the example represented in FIG. 7C), and the auto-zero sampling pre-amp (which comprises the gain stage 730) may alternatively be implemented as a pseudo differential auto-zero sampling pre-amp. For example, it may be very similar to that represented in FIG. 7C, but rather than have a differential gain stage 730 it could use two single ended gain stages, one for each of signals 115₁ and 115₂, the outputs of which would form a pseudo differential signal that is then input to the comparator 740. The sampling capacitors C1a and C1b may have a larger (potentially significantly larger, such as at least one order of magnitude larger) capacitance than the capacitance of the kTC capacitors 320 of the noise generator circuits. In this example, the sampling circuit is a single stage auto-zeroed pre-amp, although as shown in FIG. 7E it may alternatively be a multi-stage auto-zeroed pre-amp.

FIG. 7D shows a timing diagram representing an example operation of the circuit of FIG. 7C. Initially, in Step S410, the auto-zero switches AZ1 are closed, in an autozeroing state and the switches of the noise generators 110₁ and 110₂ are closed, to couple the first buffered differential signal to the auto-zeroing pre-amp. At step S420 the switch signal SW then goes low, so that the first buffered differential signal is sampled by capacitors C1a and C1b. Example differential signals 115₁ and 115₂, and vin1 and vin2 are shown in FIG. 7D. It will be appreciated that these are merely one example and that their magnitudes and relative polarity may vary depending on the kTC noise in the signals output by the noise generator circuits. The sampled first differential signal comprises a difference between the kTC noise generated by the first noise generator circuit 110₁ and the kTC noise generated by the second noise generator circuit 110₂ in the first switching event of the noise generator capacitors, as well as any DC offsets between the two signals making up the differential signal (for example, caused by one or more of low-frequency noise, offsets in the driving voltages of the noise generator circuits, offsets caused by the buffers of the noise generator circuits, etc).

Subsequent to that, the autozero state ends by opening the autozero switches AZ1, at Steps S430 and S440 the noise generator circuits are reset by closing the switches controlled by signal SW and then subsequently opened again so that a second switching event in the noise generator circuits takes place, to generate new kTC noise in their capacitors, and the second buffered differential voltage is output from the noise generator circuits. The second buffered differential voltage comprises a difference between the kTC noise generated by the first noise generator circuit 110₁ and the kTC noise generated by the second noise generator circuit 110₂ in the second switching event of the noise generator capacitors, as well as any DC offsets between the two signals making up the differential signal. The second buffered differential signal is sampled onto the capacitors C1a and C1b. Consequently, because the first and second buffered differential signals are both sampled onto the capacitors C1a and C1b without any reset of the capacitors C1a and C1B, and both sampled signals include the same (or substantially the same) DC components, the differential signal at the input to the comparator 740 represents a difference between the first buffered differential voltage and the second buffered differential voltage. Consequently, the signal at the input to the comparator 740 comprises a difference between the total kTC noise generated by the first noise generator circuit in first and second switching events, and the total kTC noise generated by the second noise generator circuit in the first and second switching events. The output of the comparator 740 is indicative of the polarity of the differential signal at its input, which in turn indicates whether the combined kTC noise generated by the first noise generator 115₁ by its two switched capacitor kTC events is greater than or less than the combined kTC noise generated by the second noise generator 115₂ by its two switched capacitor kTC events. Therefore, the output of the comparator 740 will be randomly 0 or 1. At Step S450, the comparator 740 is latched such that its output Comp_out is held at the output. In this case, Comp_out is the random number 125.

By performing auto-zeroing in this way, residual offset of the pre-amp and also offset voltages between the two buffers of the two noise generation circuits may be significantly reduced. This may help to reduce any bias in the random number 125, thereby improving the randomness of the number. Furthermore, autozeroing in this way may also help to reduce 1/f noise in the signal at the input of the comparator 740.

In each of the differential signal examples described with reference to FIGS. 6 and 7, by considering a differential voltage signal made up of the outputs of two identical noise generation circuits, at least some DC components in the signals 115₁ and 115₂ should be cancelled out so that the differential signal comprises kTC noise and any offset between the buffers of the noise generator circuits (which is then subsequently cancelled by determining the random number based two kTC noise events from each of the noise generator circuits—i.e., by determining the random number using the first and second differential signals).

Optionally, the comparator 740 may not be a latching comparator, such that its output is simply set based on a comparison of its input voltages at that time. Additionally or alternatively, the determination unit 120 may include a set/reset (SR) latch at the output of the comparator 740 to hold at the output 125 the value output by the comparator 740. Furthermore, the comparator 740 output may be single ended or differential.

FIG. 7E show an alternative implementation of the determination unit 120 of FIG. 7C, wherein rather than having a single stage sampling pre-amp, there is instead a multi-stage sampling pre-amp. In this example, there are two amplifier stages, although any number of stages may be used, for example, three, four, etc.

The determination unit 120 is the same as that represented in FIG. 7C, except for the inclusion of a second gain stage 735 with second autozeroing switches AZ2 and second sampling capacitors C2a and C2b. The second autozeroing switches AZ2 may be controlled in the same way as the first autozeroing switches AZ1 as described above with reference to FIG. 7D (optionally with a small timing offset so that AZ1 and AZ2 do not open and close at exactly the same time).

Using a multi-stage pre-amplifier may slightly increase the cost and size of the determination unit 120, but may have a benefit of improving immunity from noise and reducing mismatch between charge injection caused by the autozero switches. Therefore, it may help to improve the randomness of the output number 125.

Optionally, the determination units shown in FIGS. 7C and 7E may form a part of any other circuit, for example they may be part of a SAR ADC or slope ADC or a serial interface that is coupled to the noise generators 110 for the purpose of generating a random number 125.

Optionally, the random number generation apparatus 100 may further comprise one or more scrambling circuits configured to generate a scrambled random number.

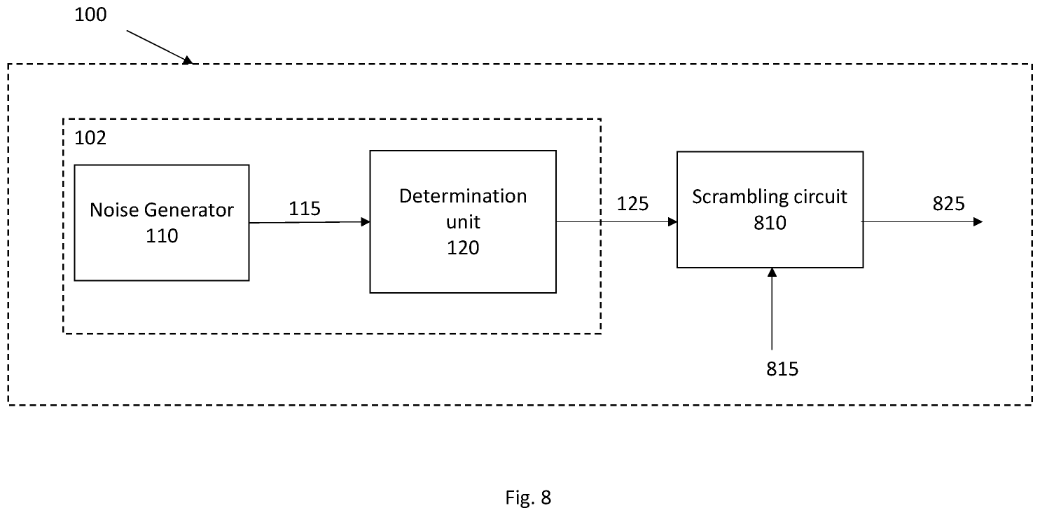

FIG. 8 shows an example random number generation apparatus 100 that further comprises a scrambling circuit 810. The random number generator 102 may be implemented in any of the ways described earlier and may generate a random number 125 in the same ways as described above. However, in this example implementation, and in all examples described below where the random number 125 is scrambled, the random number generator 102 may be implemented in any alternative way that will be well understood by the skilled person to generate a random number 125 Therefore, the random number generator 102 in this example and all subsequent examples is not limited only to the kTC capacitor implementations described earlier, but may generate the random number 125 in any way that is known to the skilled person, including technique techniques/systems that do not use kTC noise.

The scrambling circuit 810 receives the random number 125 and also receives a random or pseudo random dither signal 815. For simplicity, the signal 815 will be referred to as a dither signal 815 from now on. The dither signal 815 may be a single bit or a multibit random number. The scrambling circuit 810 is configured to generate a scrambled random number 825 by scrambling the random number 125 using the dither signal 815. For example, the scrambling circuit 810 may set the scrambled random number 825 to have the same value as the random number 125 when the dither signal 815 has a first value, and may set the scrambled random number 825 to a value that is different to the value of the internal random number 125 when the dither signal 815 has a second value. For example, the scrambling circuit 810 may be an XOR gate or XNOR gate, or a circuit/logic having the functionality of an XOR or XNOR gate, where the internal random number 125 and the dither signal 815 are inputs and the scrambled random number 825 is the output. Consequently, the scrambled random number 825 may be set as follows:

| Internal random number | | Scrambled random |
|---|---|---|
| 125 | Dither signal 815 | number 825 |
| 0 | 0 | 0 |
| 0 | 1 | 1 |
| 1 | 0 | 1 |
| 1 | 1 | 0 |

Alternatively ,the scrambling circuit 810 could be any other form of circuit/logic configured to generate the scrambled random number 825 by scrambling the internal random number 125 in dependence on the dither signal 815.

In one example, the dither signal 815 may be generated by a second random number generator that is of the same design as the random number generator 102.

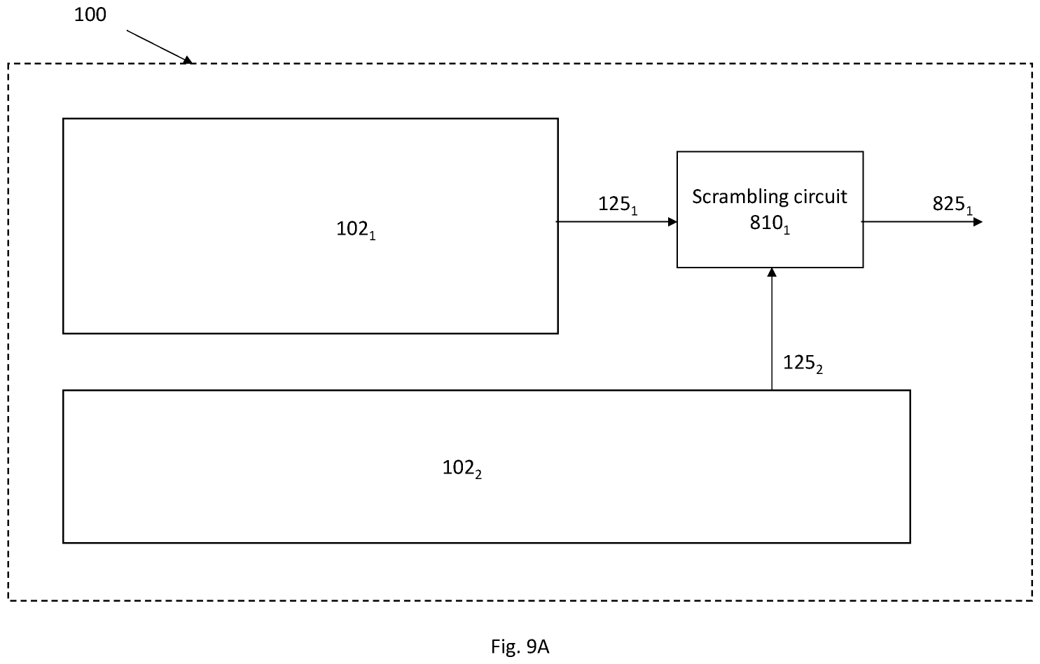

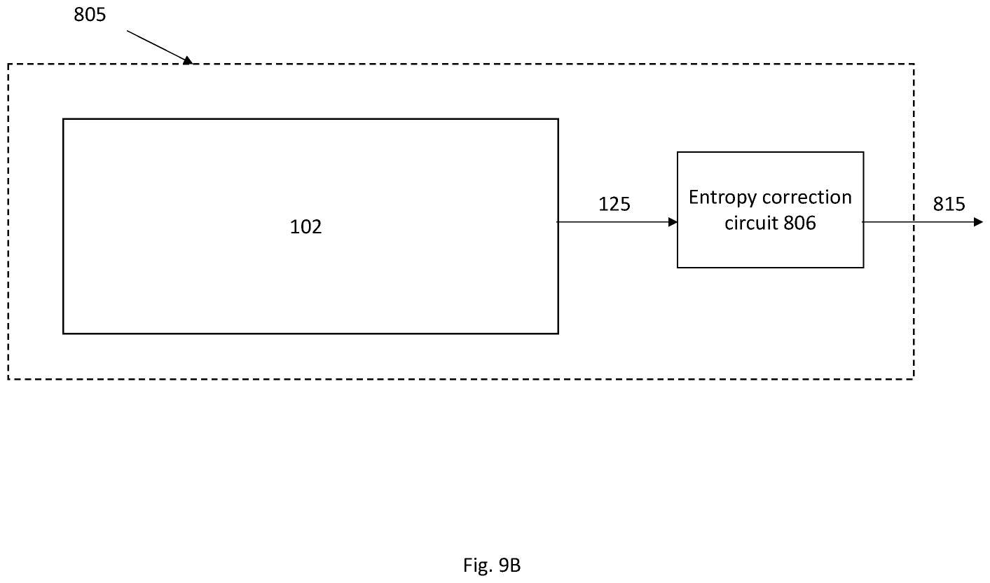

FIG. 9A shows an example of this, where the random number 1252 generated by the second random number generator 1022 is used as the dither signal for the scrambling circuit 810 of the first random number generator 102₁.

In an alternative, the dither signal may be generated by a pseudo random number generator. In a further alternative, the dither signal may be generated by a pseudo random number generator that is seeded by the output of a further random number generator 1022 that is of the same design as the first random number generator 102₁.

FIG. 9B shows one non-limiting example implementation of a dither generator 805 that comprises a random number generator 102 and an entropy correction circuit 806. The random number generator 102 outputs a random number 125 to the entropy correction circuit 806, which uses the random number 125 to generate the dither signal 815. The entropy correction circuit 806 may be configured to generate the dither signal 815 in such a way that it reduces or corrects any entropy issues in the random number 125 that would cause the random number not to have an equal likelihood for each of its possible values. In one example, the entropy correction circuit 806 may be a Von Newmann corrector configured to operate according to the Von Neumann principle that removes 0/1 bias from a random number. In particular, it may be configured to receive two consecutive values from the random number generator 102. If the two consecutive values from the random number generator 102 are “01”, the dither signal 815 is set to 0 (or 1). If the two consecutive values from the random number generator 102 are “10”, the dither signal 815 is set to 1 (or 0). If the two consecutive values from the random number generator 102 are “00” or “11”, there is no output from the correction circuit 806 (i.e., the dither signal 815 has no value) and the process is repeated until the dither signal 815 is set to a value. Thus, for each new value of the dither signal 815, at least two random values need to be generated by the random number generator 102. However, it means that the dither signal 815 should have no bias towards 1 or 0, which should then improve the randomness of the scrambled random number 825.

In an alternative, the dither generator 805 may not have the entropy correction circuit 806 and instead output the random number 102 as the dither signal 815. In a further alternative, the dither generator 805 may further comprise a pseudo-random number generator configured to be seeded by the random number 102 and output the pseudo-random number as the dither signal 815. In a further alternative, it may be implemented in any other way that is known to the skilled person.

In the examples of FIGS. 8 and 9A, the scrambling circuit 810 generates the scrambled random number 825 using only two inputs. As such, it may include just a single scrambler, for example a single XOR or XNOR gate, to perform a one-step scramble. However, in an alternative, more complex scrambler circuits may be used in order to generate the scrambled random number 825.

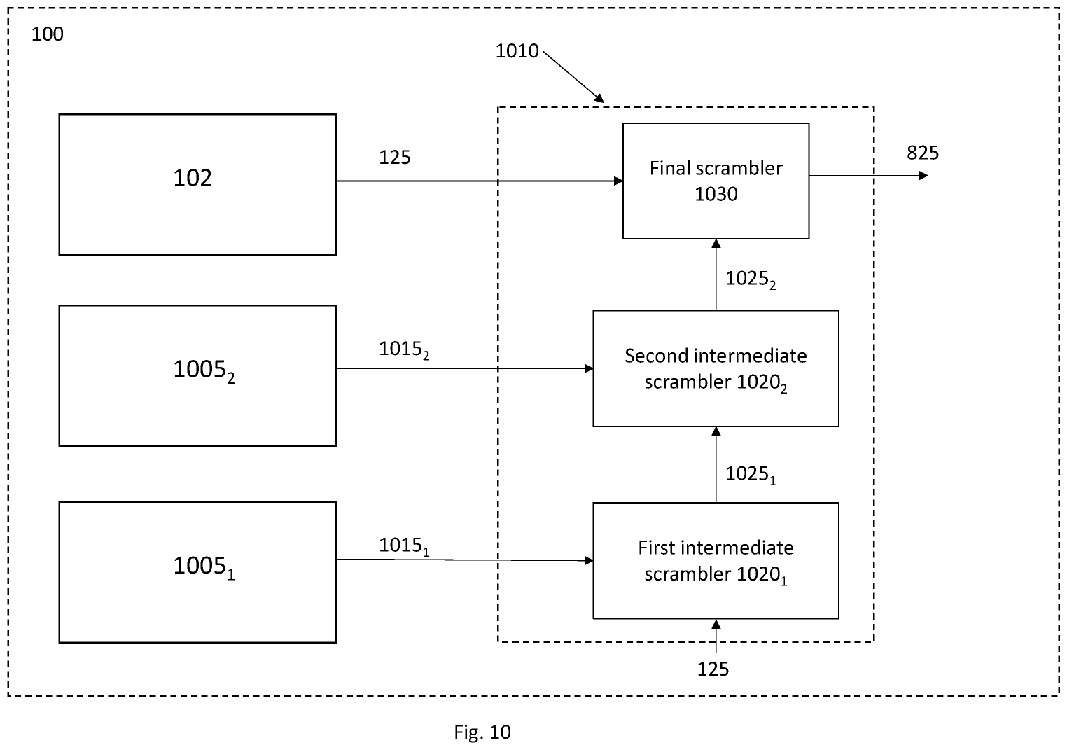

FIG. 10 shows an example of a more complex scrambling circuit 1010 configured to generate a scrambled random number 825 using a random number 125 and two or more dither signals 1008. In this example, the scrambling circuit 1010 performs cyclic scrambling using two or more scramblers (each of which may be configured to have an XOR or XNOR functionality, as described above).

The random number generation apparatus comprises a random number generator 102 and two dither generators 1005₁ and 1005₂ for generating two dither signals 1015₁ and 1015₂. The dither generators 1005 may be configured in any of the ways described above with reference to FIGS. 8 and 9. The scrambling circuit 1010 comprises three scramblers 1020₁, 1020₂ and 1030 (for example three XOR or XNOR gates). The first intermediate scrambler 1020₁ generates a first intermediate scrambled dither signal 1025₁ by scrambling the random number 125 using the first dither signal 1015₁, in the same way as described above with reference to FIGS. 8 and 9). The second intermediate scrambler 1020₂ then generates a second intermediate scrambled dither signal 1025₂ by scrambling the second dither signal 1015₂ using the first intermediate scrambled dither signal 1025₁, in the same way as described above with reference to FIGS. 8 and 9. Finally, the final scrambler 1030 generates the scrambled random number 825 by scrambling the random number 125 using the second intermediate scrambled dither signal 1025₂, in the same way as described above with reference to FIGS. 8 and 9.

It will be appreciated that in this example, two dither signals 1015 and three scramblers are used. However, the principle of this circuit may be extended to any number of dither signals 1015 and scramblers 1020.

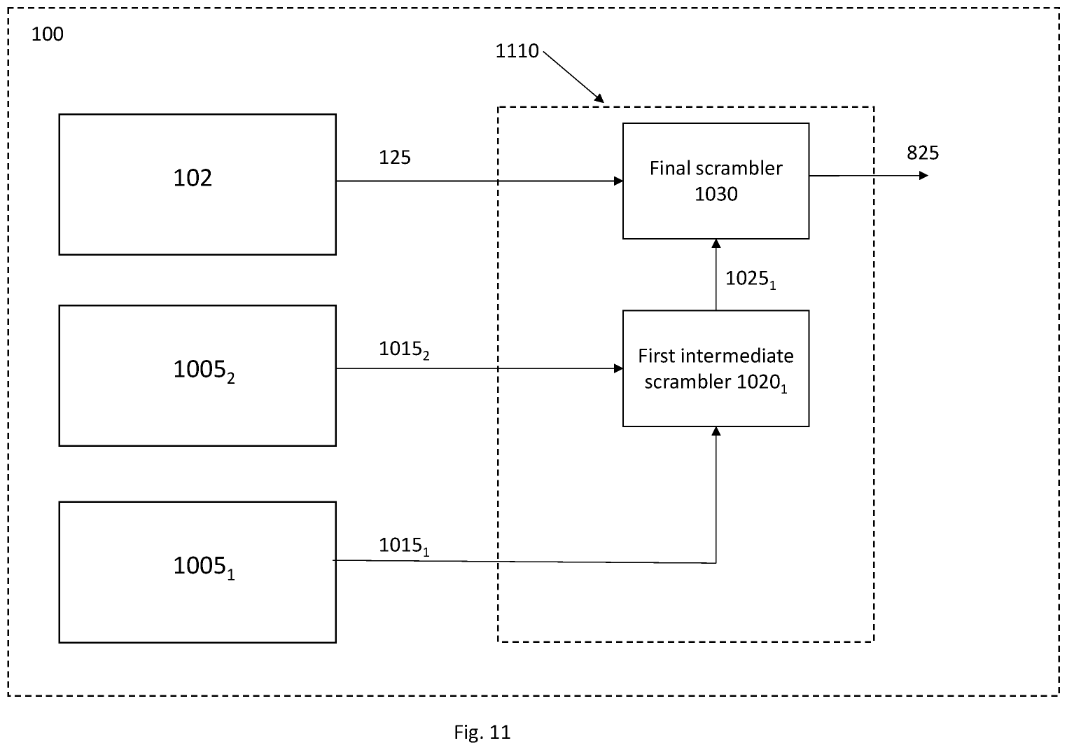

FIG. 11 shows a further example scrambling circuit 1110 that includes multiple scramblers in order to perform more complex scrambling. In this example, the scrambling circuit 1110 is configured to perform a two-step scramble. The two step scramble is very similar to the cyclic scramble described above, except that the first intermediate scrambler 1020₁ scrambles the first and second dither signals 1015₁ and 1015₂ to generate the first intermediate scrambled dither signal 1025₁. The final scrambler 1030 then generates the scrambled random number 825 by scrambling the random number 125 using the first intermediate scrambled dither signal 1025₁, in the same way as described above with reference to FIGS. 8 and 9.

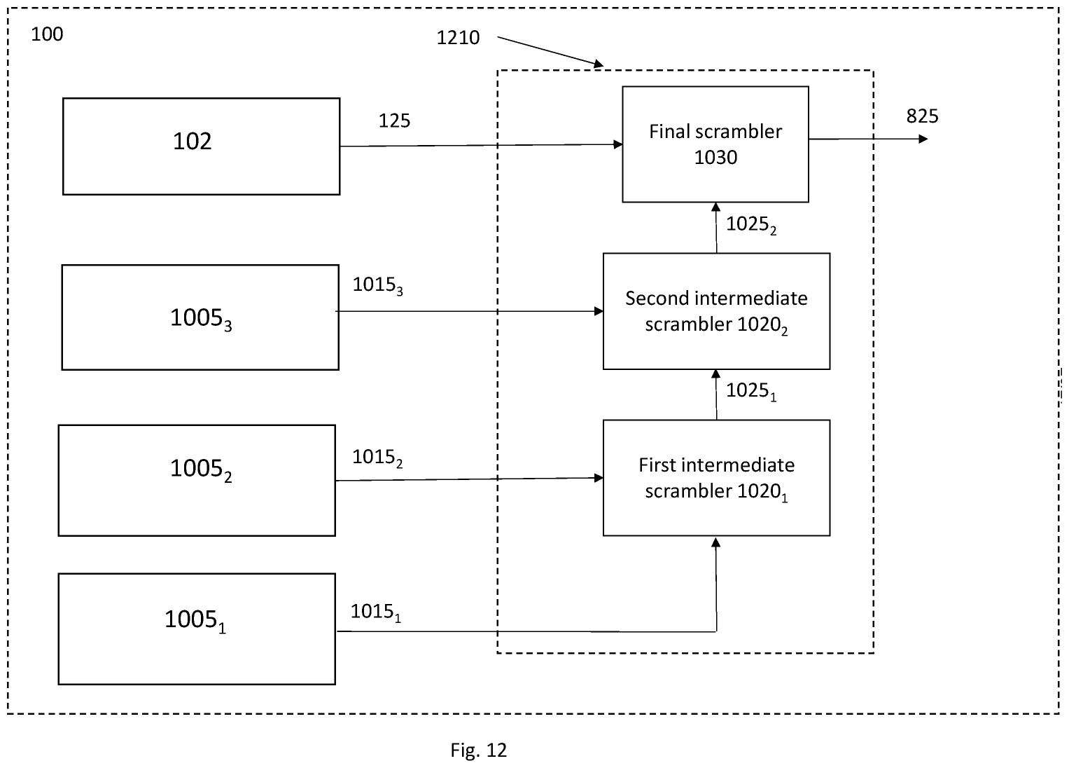

FIG. 12 shows a further example scrambling circuit 1210 that is very similar to FIG. 11, except that it is configured to perform a three-step scramble. It will be appreciated that FIGS. 11 and 12 show multi-step scrambling, which may be extended to any number of scrambling steps, for example, two, three, four, etc.

Generating and using one or more intermediate dither signals in the ways described above may improve the entropy of the dither signal that is used by the final scrambler 1030 to scramble the random number 125 and generate the scrambled random number 825. Consequently, the scrambled random number 825 may have improved entropy compared with the examples of FIGS. 8 and 9 and therefore be a more random number (i.e., a more equal likelihood of having each possible value, for example a likelihood of being a 0 or 1 that is closer to 50:50).

In each of these examples, each scrambler within the scrambling circuit 1110 generates a scrambled output signal using two input signals. However, in an alternative, at least one of the scramblers may use three or more inputs to generate a scrambled output (for example, it may be, or have the functionality of, a 3+ input XOR or XNOR gate). For example, considering the implementation of FIG. 11, rather than having two scramblers, a single three input scrambler could be used, with the random number 125, first dither signal 1015₁ and second dither signal 1015₂ being used to generate the scrambled random number.

Using a scrambling circuit in any of the ways described above with reference to FIGS. 8 to 12, and in any of the further ways described below, may be beneficial for hiding power signatures of the random number generation apparatus 100, thereby reducing the chance that malicious external parties can understand the operations of the apparatus from external operations. This may reduce the chance of the generated random number being compromised by malicious external parties. Furthermore, scrambling results in a scrambled random number 825 with increased entropy compared with the random number 125. Consequently, if there is any residual bias in the random number 125 such that the output does not have a 50:50 chance of a 0 or 1, that bias should be reduced or eliminated in the scrambled random number 825 such that the finally generated and output scrambled random number should have a likelihood of a 0 or 1 that is closer to 50:50. The scrambled random number 825 can then be output by the random number generation apparatus 100 to any device/entity that requires a random number. Using an intermediate dither signal to scramble the random number 125, for example as shown in any of FIGS. 10 to 12, may further improve the entropy of the scrambled random number 825 such that its randomness is even further improved.

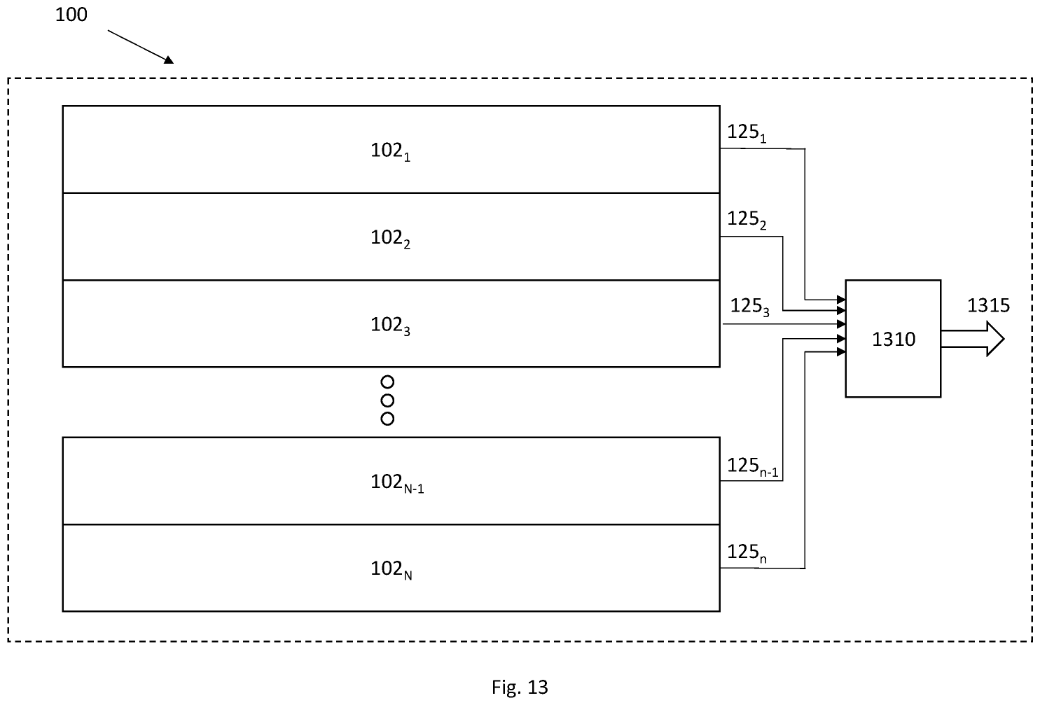

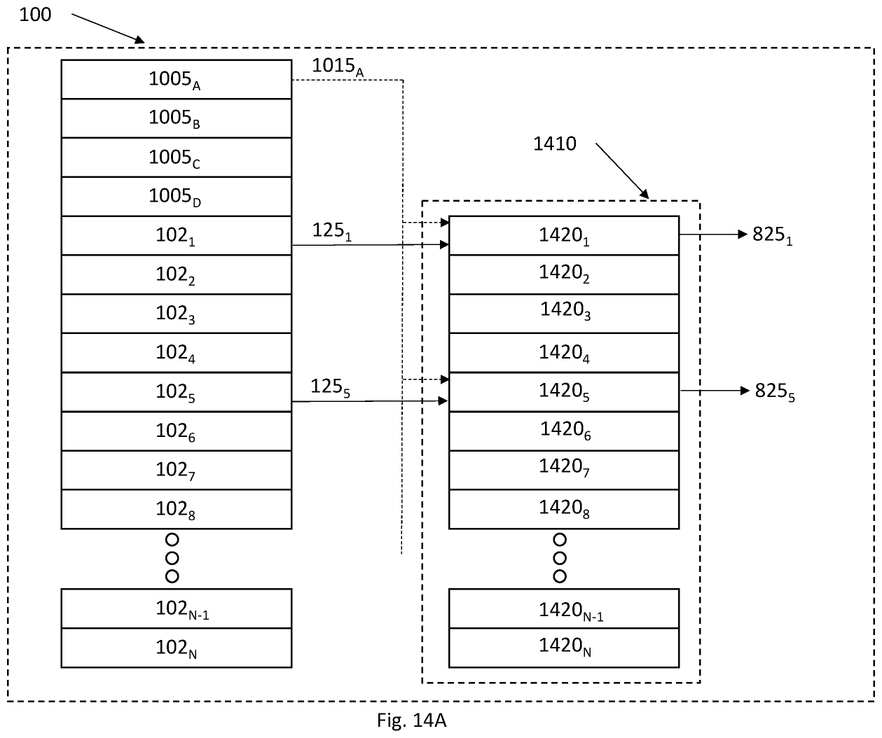

FIG. 13 shows an example schematic representation of a random number generation apparatus 100 comprising a plurality of random number generators 102ₙ. In this example, there are N random number generators, numbered 102₁ to 102_{N}. Each random number generator 102ₙ may be implemented in any of the ways described above. The apparatus further comprises a multi-bit random number unit 1310 that receives the random numbers 125ₙ generated by the random number generators 102ₙ. The multi-bit random number unit 1310 may be implemented in any suitable way to achieve the functionality described below, for example in hardware such as fixed circuits or logic, or software executed on one or more processors, such as a microprocessor or microcontroller.

The multi-bit random number generator 1310 may be configured to generate a multi-bit random number 1315 based on at least some of the received random numbers 125ₙ. By generating a multi-bit random number 1315 using random numbers 125ₙ generated by multiple different random number generators 102ₙ, the entropy of the multi-bit random number 1315 may be improved and as a result any systematic bias in any of the random numbers 125ₙ may be reduced or removed from the multi-bit random number 1315.

The multi-bit random number generator 1310 may generate the multi-bit random number 1315 in a number of different ways. For example, it may simply concatenate at least some of the received random numbers 125ₙ. In this case, each time a new multi-bit random number 1315 is generated, the newly generated random numbers 125ₙ may always be concatenated in the same order, or the ordering may change for each new multi-bit random number 1315. In a further example, more complex operations may be performed on the received random numbers 125ₙ in order to generate the multi-bit random number 1315, such as XORing, or hashing, etc. In one example, only some of the received random numbers 125ₙ may be used to generate the multi-bit random number 1315, and optionally which of the random numbers 125ₙ are used may change for each new multi-bit random number 1315. In the cases where there are changes to the ordering of concatenation and/or changes to which random numbers 125ₙ contribute to the multi-bit random number 1315, those changes may be random or pseudo random. For example, the outputs of one or more of the random number generators 102ₙ may not be used for the multi-bit random number 1315, but may instead be used to randomise the changes.

In some examples, the multi-bit random number 1315 may be generated from one set of random numbers 102ₙ. In another example, the multi-bit random number generator 1310 may store multiple values of at least some of the random numbers 102ₙ over time and then use those values to generate the multi-bit random number 1315. In this way, the length of the multi-bit random number 1315 may be longer than the number of random number generators 102, whose outputs are used by the multi-bit random number generator 1310.

At least some of the random number generators 102, may operate in parallel such that they each generate a new random number 125ₙ at the same time. This may improve the speed at which a multi-bit random number 1315 may be generated, for example compared with using a single random number generator to generate a multi-bit random number 1315. Furthermore, it may improve the security of the apparatus 100 by disguising power signatures and/or the current footprint of the random number generators 102ₙ, thereby reducing the possibility of side-channel attacks that could compromise the random number generated and output by the apparatus 100.

In the example of FIG. 13, the multi-bit random number generator 1310 generates the multi-bit random number 1315 using the plurality of random numbers 125ₙ. However, in an alternative a scrambling circuit may be used to scramble the random numbers 125ₙ and the multi-bit random number generator 1310 generate the multi-bit random number 1315 using the scrambled random numbers.

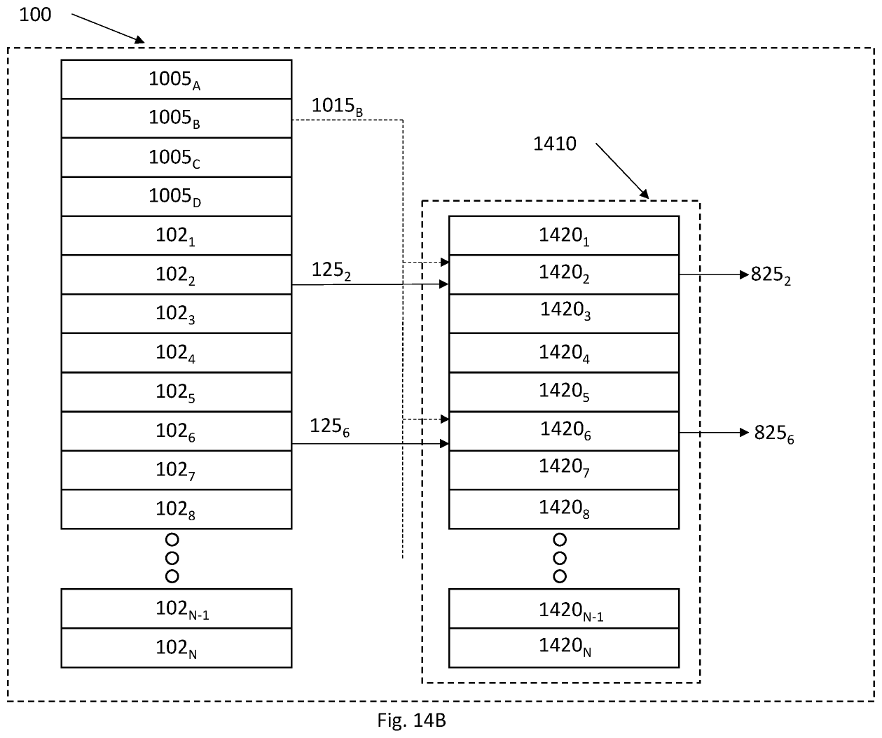

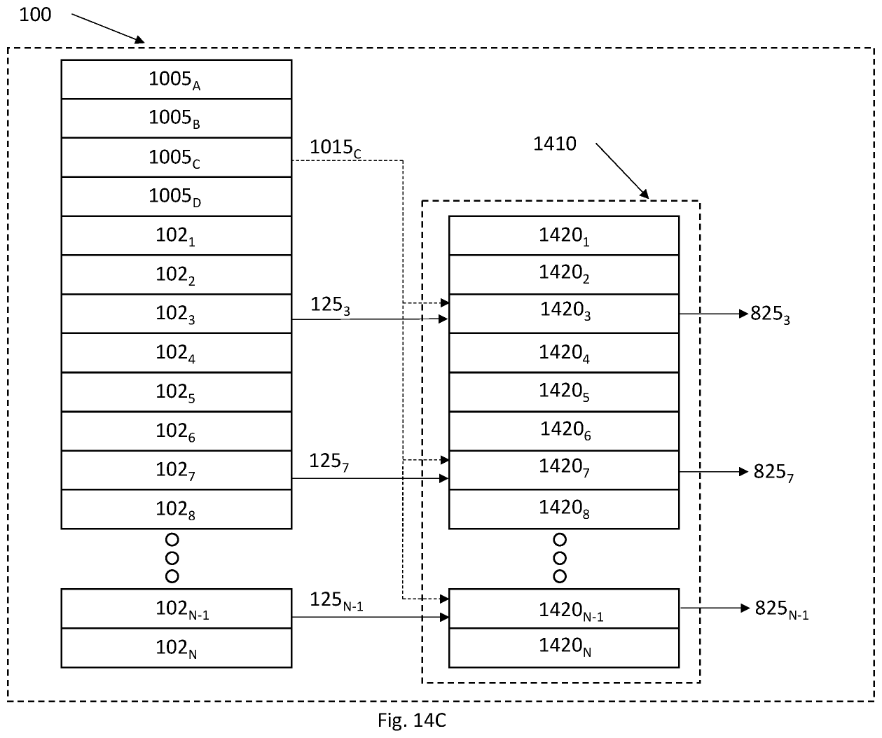

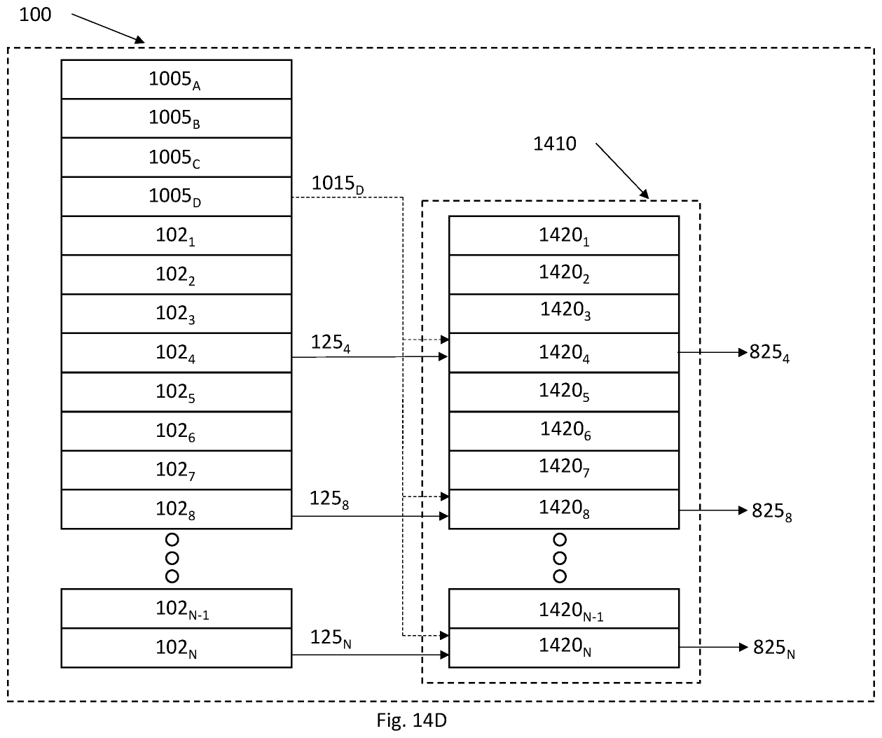

FIGS. 14A to 14D shows an example implementation of a scrambling circuit 1410 used to scramble a plurality of random numbers 125ₙ and generate a plurality of scrambled random numbers 825ₙ. In this example, there are a plurality of scramblers 1420n, each configured to scramble a respective random number 125ₙ. In this example, the random number generators 102ₙ are spatially arranged in a row as a series of adjacent columns (which is equivalent to being arranged in a column as a series of adjacent rows). The apparatus 100 also includes a plurality of dither generators 1005 (in this example four, although there could be any number, for example one, two, three, five, etc) configured to output dither signals 1015. The dither generators 1005 are also included as part of the row of random number generators 102ₙ, although they do not have to be. For example, the random number generators 102ₙ and the dither generators 1005 may all be implemented in the same integrated circuit (IC) and spatially arranged in a row as known in FIGS. 14A to 14D. To be clear, in this example (as in all scrambling examples disclosed herein), the random number generators 102ₙ and the dither generators 1005 may be implemented in any way known to the skilled person, including (but not limited to) the ways described herein with reference to FIGS. 1 to 7.

The apparatus 100 is configured such that the first dither signal 1015A is used by multiple scramblers 1420 to scramble their respective random numbers 125, wherein the random number generators 102 that generate those random numbers 125 are spatially separated (i.e., they are spatially non-adjacent to each other in the row/column of random number generators 102ₙ, such that there is at least one other random number generator 102 between them in the row/column). For example, random numbers 125₁, 125₅, 125₉, etc are scrambled by scramblers 1420₁, 1420₅, 1420₉, etc using the first dither signal 1015_{A}. Likewise, as can be seen in FIG. 14B, the second dither signal 1015_{B} is used by other scramblers 1420 to scramble their respective random numbers 125, wherein the random number generators 102 that generate those random numbers 125 are spatially separated (i.e., they are spatially non-adjacent to each other in the row/column of random number generators 102ₙ). For example, random numbers 125₂, 125₆, 125₁₋, etc are scrambled by scramblers 1420₂, 1420₆, 1420₁₀, etc using the second dither signal 1015_{B}. Likewise, the same is true for the third dither signal 1015_{C}, as seen in FIG. 14C, and the fourth dither signal 1015_{D}, as seen in FIG. 14D.

Furthermore, the dither generators 1005 all occupy a position in the row that is spatially non-adjacent to the random number generator(s) 102ₙ whose output is scrambled using the dither signal generated by the dither generator.

Performing scrambling using signals that are generated by units/elements that are non-adjacent to each other in the row may help to improve the randomness of the scrambled random numbers 825_{N}. For example, there may be manufacturing imperfections in one area of the IC that may cause a bias in the random numbers generated in that area. By performing scrambling using random numbers/signal that are generated in non-adjacent positions of the row, and therefore in different areas of the IC, any bias caused by imperfections in a particular part of the IC should be reduced or eliminated. Additionally or alternatively, correlation between the dither signal(s) and the random number that is being scrambled by the dither signal(s) should be reduced or eliminated, but virtue of reducing/preventing capacitive coupling between the units/elements that generate the dither signal and the random number.

FIGS. 14A-14D show a straightforward form of scrambling, similar to that represented in FIGS. 8 and 9. However, in an alternative, more complex scrambling akin to the examples described above with reference to FIGS. 10 to 12 may be used.

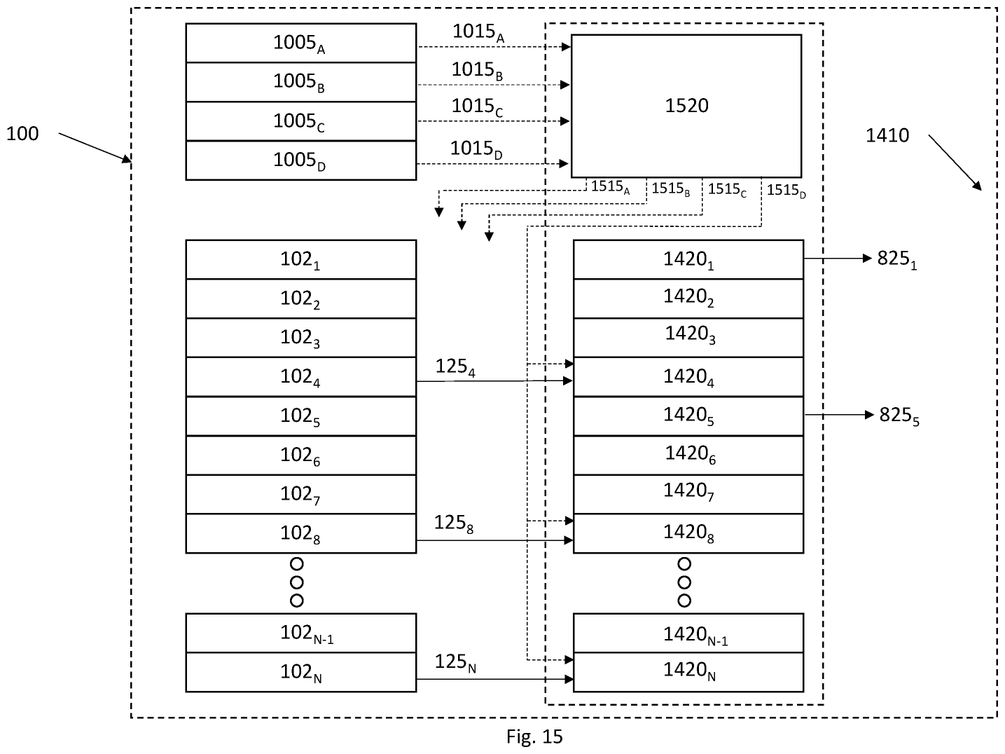

FIG. 15 shows an example of this, where the scrambling circuit 1510 includes an intermediate scrambling circuit 1520 (which will include one or more intermediate scramblers 1020, each of which may have two or more inputs and generate their intermediate dither signal using those two or more inputs) and a plurality of final scramblers 1420_{N}. The intermediate scrambling circuit 1520 is configured to receive a plurality of dither signals 1015 (in this example, four dither signals 1015_{A} to 1015_{D}, although it could be any other number) and generate one or more intermediate dither signals 1515 (in this example, four intermediate dither signals 1515_{A} to 1515_{D}, although it could be any other number). The intermediate dither signals 1515 may then be used by the final scramblers 1420_{N} in the same way as the scramblers 1420n of FIG. 14 use the dither signals 1015_{A} to 1015_{D} (i.e., spatially adjacent random number generators 102 may have their random numbers 125 scrambled by different intermediate dither signals 1515, or put another way, each intermediate dither signal 1515 may be used to scramble two or more random numbers 125 output by spatially non-adjacent random number generators 102). FIG. 15 shows an example way in which the fourth intermediate dither signal 1515_{D} may be used, which is the same as the way in which the fourth dither signal 1015_{D} is used in FIG. 14_{D}.I It will be appreciated that the other intermediate dither signals 1515 may be used in the same way as the dither signals shown in FIGS. 14A to 14C and they are not represented in the drawings merely for the sake of clarity and simplicity.

The intermediate scrambling circuit 1520 may perform one step of scrambling to generate the intermediate dither signals 1515, similar to FIG. 11, or multiple steps of scrambling, similar to FIG. 12. For example, in a one intermediate step scrambling implementation (similar to that of FIG. 11), the first intermediate dither signal 1515_{A} may be generated by a first intermediate scrambler using the first dither signal 1015_{A} and the second dither signal 1015_{B}, the second dither signal 1515_{B} may be generated by a second intermediate scrambler using the second dither signal 1015_{B} and the third dither signal 1015_{C}, the third dither signal 1515_{C} may be generated by a third intermediate scrambler using the third dither signal 1015_{C} and the fourth dither signal 1015_{D}, and the fourth dither signal 1515_{D} may be generated by a fourth intermediate scrambler using the fourth dither signal 1015_{D} and the first dither signal 1015_{A}. Additionally or alternatively, the intermediate scrambling circuit 1520 may include one or more scramblers with 3+ inputs, for example generating an intermediate dither signal based on at least three of the dither signals 1015. Irrespective of the number of scrambling steps undertaken by the intermediate scramble circuit 1520 to generate the intermediate dither signals 1515, the scrambles 1420_{N} function as final scrambler for each of the random numbers 125_{N}, and therefore perform the same function as the final scrambler 1030 of FIGS. 11 and 12.

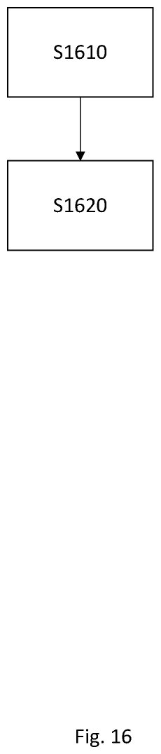

FIG. 16 shows an example process of generating a scrambled random number using any of the implementations of the random number generation apparatus described above with reference to FIGS. 8 to 14. In Step S1410 a first random number is generated. In Step S1420, a scrambled random number is generated based on the first random number and the first dither signal, wherein the first dither signal is a random value signal or a pseudo-random value signal.

The skilled person will readily appreciate that various alterations or modifications may be made to the above described aspects of the disclosure without departing from the scope of the disclosure.

The terminology “coupled” used herein encompasses both a direct electrical connection between two components, and an indirect electrical connection where the two components are electrically connected to each other via one or more intermediate components.

In each of the examples implementations of the noise generator circuit 110 disclosed above, the capacitor 320 generating kTC noise is represented as a separate component. However, in an alternative the capacitor in the noise generator circuit 110 may be a parasitic capacitance at any of the junctions, gates or metal overlaps of the buffer in the noise generator circuit 110. Therefore, the noise generator circuit 110 does not necessarily include an explicit capacitor component, but may instead include a buffer that has parasitic capacitance that effectively forms the capacitor. This may have a benefit of the capacitor 320 having a very small capacitance (since parasitic capacitances tend to be very small), which helps with kTC noise generation, without requiring a capacitor component to be included in the noise generator circuit 110.

### ASPECTS OF THE DISCLOSURE

Some non-limiting aspects of the disclosure are set out in the following numbered clauses:
1. An apparatus for generating a scrambled random number, the apparatus comprising:
a first random number generator configured to generate a first random number;
a scrambling circuit configured to receive the first random number and a first dither signal, and generate the scrambled random number based on the first random number and the first dither signal,
wherein the first dither signal is a random value signal or a pseudo-random value signal.
2. The apparatus of clause 1, wherein the scrambling circuit is configured to generate the scrambled random number by setting the scrambled random number to equal the value of the first random number when the first dither signal is a first value and setting the scrambled random number to a value that is different to the first random number when the first dither signal is a second value.
3. The apparatus of clause 2, wherein when the first dither signal is the second value, the scrambled random number is set to an inverse of the first random number.
4. The apparatus of any of clauses 1 to 3, further comprising:
a first dither generator for generating the first dither signal.
5. The apparatus of clause 4, wherein the first dither generator comprises a further random number generator configured to generate a further random number,
wherein the first dither generator is configured to generate the first dither signal using the further random number.
6. The apparatus of clause 5, wherein the first dither generator further comprises a first pseudo-random number generator configured to use the further random number as a seed for generating the first dither signal, wherein the first dither signal is a pseudo-random number output by the first pseudo-random number generator.
7. The apparatus of clause 5, wherein the first dither generator further comprises an entropy correction circuit configured to generate the first dither signal based on the further random number.
8. The apparatus of clause 7, wherein the entropy correction circuit is a Von Neumann corrector.
9. The apparatus of any of clauses 1 to 8, further comprising:
a plurality of random number generators that includes the first random number generator, wherein the plurality of random number generators are configured to generate a respective plurality of random numbers; and
a first dither generator configured to generate the first dither signal, and
wherein the scrambling circuit is configured to receive the plurality of random numbers and the first dither signal, and generate a respective plurality of scrambled random numbers using the plurality of random numbers and the first dither signal.
10. The apparatus of clause 9, wherein plurality of random number generators and the first dither generator are implemented in an integrated chip and are spatially arranged in a row.
11. The apparatus of clause 10, wherein the scrambling circuit is configured to scramble at least two random numbers of the plurality of random numbers using the first dither signal, wherein the at least two random numbers are generated by two random number generators that are spatially non-adjacent in the row.
12. The apparatus of clause 11, wherein the first dither generator occupies a position in the row that is spatially non-adjacent to the two random number generators that generate the at least two random numbers.
13. The apparatus of any of clauses 9 to 12 further comprising:
a second dither generator configured to generate a second dither signal,
wherein the scrambling circuit is configured to receive the second dither signal, and generate a first set of scrambled random numbers using a first set of random numbers and the first dither signal, and generate a second set of scrambled random numbers using a second set of random numbers and the second dither signal,
wherein the plurality of random numbers comprise the first set of random numbers and the second set of random numbers, and
wherein the plurality of scrambled random numbers comprise the first set of scrambled random numbers and the second set of scrambled random numbers.
14. The apparatus of any of clauses 1 to 13, wherein the scrambling circuit is further configured to:
receive one or more further dither signals; and
generate the scrambled random number based on the first random number, the first dither signal and the one or more further dither signals.
15. The apparatus of clause 14, wherein the scrambling circuit is configured to:
generate an intermediate dither signal using the first dither signal and the one or more further dither signals; and
generate the scrambled random number using the first random number and the scrambled dither signal.

1. A random number generation apparatus comprising a first random number generator that comprises:
a first noise generator circuit comprising:
a first capacitor for use in generating kTC noise; and
a first buffer coupled to the first capacitor to buffer a capacitor voltage comprising kTC noise generated by the first capacitor and output a buffered voltage; and
a determination unit configured to:
readout a first buffered voltage from an output of the first buffer, wherein the first buffered voltage is a buffered version of a first capacitor voltage comprising first kTC noise generated by the first capacitor at a first time; and
readout a second buffered voltage from the output of the first buffer, wherein the second buffered voltage is a buffered version of a second capacitor voltage comprising second kTC noise generated by the first capacitor at a second time,
wherein the random number generation apparatus is configured to generate a random number based on the first buffered voltage and the second buffered voltage.

2. The random number generation apparatus of claim 1, wherein the noise generator circuit further comprises:
a first switch coupled to the first capacitor so as to form a first switched capacitor arrangement such that changing a state of the first capacitor from closed to open generates at the first capacitor a capacitor voltage comprising kTC noise.

3. The random number generation apparatus of claim 1, wherein the first buffer is configured to apply a gain to the capacitor voltage to generate the buffered voltage.

4. The random number generation apparatus of claim 1, wherein the determination unit comprises:
a sampling circuit configured to sample the first buffered voltage.

5. The random number generation apparatus of claim 4, wherein the sampling circuit comprises an amplifier comprising at least one capacitor, wherein the sampling circuit is configured to sample the first buffered voltage using the at least one capacitor.

6. The random number generation apparatus of claim 5, wherein the amplifier is an auto-zeroed amplifier.

7. The random number generation apparatus of claim 4, wherein the determination unit comprises:
a comparator configured to compare the sampled first buffered voltage against the second buffered voltage, wherein generation of the random number is based on an output of the comparator.

8. The random number generation apparatus of claim 1, wherein
the first random number generator further comprises:
a second noise generator circuit comprising:
a second capacitor for use in generating kTC noise; and
a second buffer coupled to the second capacitor to buffer a capacitor voltage comprising kTC noise generated by the second capacitor and output a buffered voltage;
wherein the determination unit is further configured to:
readout a third buffered voltage from an output of the second buffer, wherein the third buffered voltage is a buffered version of a third capacitor voltage comprising third kTC noise generated by the second capacitor at the first time, and wherein the first buffered voltage and the third buffered voltage together form a first differential signal; and
readout a fourth buffered voltage from the output of the second buffer, wherein the fourth buffered voltage is a buffered version of a fourth capacitor voltage comprising fourth kTC noise generated by the second capacitor at the second time, and wherein the second buffered voltage and the fourth buffered voltage together form a second differential signal,
wherein the random number generation apparatus is configured to generate the random number based on the first differential signal and the second differential signal.

9. The random number generation apparatus of claim 8, wherein the determination unit comprises:
an auto-zeroing differential sampling circuit configured to sample the first differential signal.

10. The random number generation apparatus of claim 9, wherein the determination unit is configured to generate the random number based on determining a difference between the second differential signal and the sampled first differential signal.

11. The random number generation apparatus of claim 1, wherein the random number generation apparatus further comprises a scrambling circuit configured to receive the random number generated by the first random number generator and a dither signal that is a random value signal or a pseudo-random value signal, and
wherein the scrambling circuit is configured to generate a scrambled random number based on the dither signal and the random number generated by the first random number generator.

12. The random number generation apparatus of claim 11, wherein the scrambling circuit is configured to generate the scrambled random number by setting the scrambled random number to equal the random number generated by the first random number generator when the dither signal is a first value and setting the scrambled random number to a value that is different to the random number generated by the first random number generator when the dither signal is a second value.

13. The random number generation apparatus of claim 12, wherein when the dither signal is the second value, the scrambled random number is set to an inverse of the random number generated by the first random number generator.

14. A method for generating a random number, the method comprising a first noise generator circuit comprising:
generating a first buffered voltage output from a buffer, wherein the first buffered voltage comprises first kTC noise generated by a capacitor at a first time;
generating a second buffered voltage output from the buffer, wherein the second buffered voltage comprises second kTC noise generated by the capacitor at a second time; and
generating a random number based on the first buffered voltage and the second buffered voltage.

15. An apparatus for generating a scrambled random number, the apparatus comprising:
a first random number generator configured to generate a first random number;
a scrambling circuit configured to receive the first random number and a first dither signal, and generate the scrambled random number based on the first random number and the first dither signal,
wherein the first dither signal is a random value signal or a pseudo-random value signal.

16. The apparatus of claim 15, wherein the scrambling circuit is configured to generate the scrambled random number by setting the scrambled random number to equal the value of the first random number when the first dither signal is a first value and setting the scrambled random number to a value that is different to the first random number when the first dither signal is a second value.

17. The apparatus of claim 15, further comprising:
a first dither generator for generating the first dither signal,
wherein the first dither generator comprises a further random number generator configured to generate a further random number, and
wherein the first dither generator is configured to generate the first dither signal using the further random number.

18. The apparatus of claim 17, wherein the first dither generator further comprises an entropy correction circuit configured to generate the first dither signal based on the further random number.

19. The apparatus of claim 15, further comprising:
a plurality of random number generators that includes the first random number generator, wherein the plurality of random number generators are configured to generate a respective plurality of random numbers; and
a first dither generator configured to generate the first dither signal, and
wherein the scrambling circuit is configured to receive the plurality of random numbers and the first dither signal, and generate a respective plurality of scrambled random numbers using the plurality of random numbers and the first dither signal.

20. The apparatus of claim 19, wherein plurality of random number generators and the first dither generator are implemented in an integrated chip and are spatially arranged in a row/column, and
wherein the scrambling circuit is configured to scramble at least two random numbers of the plurality of random numbers using the first dither signal, and
wherein the at least two random numbers are generated by two random number generators that are spatially non-adjacent in the row.
